(19) United States
(12) Patent Application Publication
(10) Pub. No.: US 2018/0062389 A1
(43) Pub. Date: Mar. 1, 2018

(54) CONTROL DEVICE, APPARATUS CONTROL DEVICE, CONTROL SYSTEM, CONTROL METHOD, AND PROGRAM

(71) Applicant: NEC CORPORATION, Tokyo (JP)

(72) Inventor: Ryo HASHIMOTO, Tokyo (JP)

(21) Appl. No.: 15/562,701

(22) PCT Filed: Mar. 29, 2016
(86) PCT No.: PCT/JP2016/060018

§ 371 Date: Sep. 28, 2017

(30) Foreign Application Priority Data
Mar. 30, 2015 (JP) 2015-068856

(51) Int. Cl. H02J 3/14; H02J 13/00

(52) U.S. Cl. CPC H02J 3/14; H02J 3/382; H02J 13/00

(57) ABSTRACT

This control device is provided with: a generation unit that, on the basis of status information of a portion of a plurality of power supply/demand adjustment devices that was received from the portion of the plurality of power supply/demand adjustment devices, generates operation control information of the portion of power supply/demand adjustment devices, and a transmission unit that transmits the operation control information to the portion of power supply/demand adjustment devices.

### TECHNICAL FIELD

The present invention relates to a control device, an apparatus control device, a control system, a control method, and a program for controlling a power supply/demand adjustment device.

### BACKGROUND ART

Methods of using a power supply/demand adjustment device such as a storage battery are known as methods of carrying out power supply/demand adjustment.

Patent Document 1 discloses a power grid control system that uses a plurality of storage batteries to perform power supply/demand adjustment.

In the power system control system described in Patent Document 1, a hierarchical supply/demand control device receives information of each storage battery (for example, the charging efficiency or residual capacity) from each of the plurality of storage batteries.

The hierarchical supply/demand adjustment device draws together the information of each storage battery.

The hierarchical supply/demand control device transmits consolidated storage battery information that is the summarized storage battery information to a higher-order device and then receives control information for the consolidated storage batteries.

The hierarchical supply/demand control device generates control information of each storage battery on the basis of received control information and the information of each storage battery.

The hierarchical supply/demand control device uses the control information of each storage battery to control the charging/discharging of each storage battery.

### LITERATURE OF THE PRIOR ART

### Patent Documents

Patent Document 1: JP 5460622B

### SUMMARY

### Problem to be Solved by the Invention

The power grid control system described in Patent Document 1 has the problem that, when the number of storage batteries that are one example of power supply/demand adjustment devices becomes large, the amount of communication processing with the storage batteries becomes voluminous. This problem arises not only when the power supply/demand adjustment devices are storage batteries but also when the power supply/demand adjustment devices are devices other than storage batteries (such as power generation devices, electrical machinery and apparatuses, and electric vehicles).

It is an object of the present invention to provide a control device, an apparatus control device, a control system, a control method, and a program that can solve the above-described problem.

### Means for Solving the Problem

An exemplary aspect of the control device of the present invention is a control device that controls a plurality of power supply/demand adjustment devices that is provided with:

a generation unit that, on the basis of status information of a portion of the plurality of power supply/demand adjustment devices that was received from the portion of power supply/demand adjustment devices, generates operation control information of the portion of power supply/demand adjustment devices; and

a transmission unit that transmits the operation control information to the portion of power supply/demand adjustment devices.

An exemplary aspect of the apparatus control device of the present invention is an apparatus control device that controls the operation of a supply/demand adjustment device that is connected to a power system and includes:

detection means that detects the status of the supply/demand adjustment device;

communication means that transmits the detection result of the detection means to an external device and that receives from the external device operation control information that controls the operation of the supply/demand adjustment device; and

control means that replaces operation control information that is being held with operation control information that was received from the communication means and, on the basis of the operation control information following replacement, controls the operation of the supply/demand adjustment device.

An exemplary aspect of the control system of the present invention includes a first control device that controls the operation of a power supply/demand adjustment device that is connected to a power system and a second control device that communicates with the first control device, wherein:

the first control device includes:

a detection unit that detects a status relating to the power supply/demand adjustment device;

a communication unit that transmits to the second control device status information that indicates the status relating to the power supply/demand adjustment device that was detected in the detection unit and that receives from the second control device operation control information that controls the operation of the power supply/demand adjustment device; and

a control unit that replaces operation control information that is being held with operation control information that was received by the communication unit and that controls the operation of the power supply/demand adjustment device on the basis of the operation control information; and

the second control device includes:

a generation unit that, on the basis of status information of a portion of a plurality of power supply/demand adjustment devices that was received from the portion of power supply/demand adjustment devices, generates operation control information of the portion of power supply/demand adjustment devices; and

a transmission unit that transmits the operation control information to the portion of power supply/demand adjustment devices.

An exemplary aspect of the control method of the present invention includes steps of on the basis of status information of a portion a plurality of power supply/demand adjustment devices that was received from the portion of the power supply/demand adjustment devices, generating operation control information of the portion of power supply/demand adjustment devices; and

transmitting the operation control information to the portion of power supply/demand adjustment devices.

Alternatively, an exemplary aspect of the control method includes steps of:

detecting the status of a supply/demand adjustment device that is connected to a power system;

transmitting the detection result of the status of the supply/demand adjustment device to an external device and receiving from the external device operation control information that controls the operation of the supply/demand adjustment device; and

replacing operation control information that is being held with operation control information that was received and, on the basis of the operation control information following replacement, controlling the operation of the supply/demand adjustment device.

An exemplary aspect of the program of the present invention is a program that causes a computer to execute a generation procedure of, on the basis of status information of a portion of a plurality of power supply/demand adjustment devices that was received from the portion of power supply/demand adjustment devices, generating operation control information of the portion of power supply/demand adjustment devices; and

a transmission procedure of transmitting the operation control information to the portion of power supply/demand adjustment devices.

Alternatively, an exemplary aspect of the program is a program that causes a computer to execute:

a detection procedure of detecting a status of a supply/demand adjustment device that is connected to a power system;

a communication procedure of transmitting the detection result of the status of the supply/demand adjustment device to an external device and receiving operation control information that controls the operation of the supply/demand adjustment device from the external device; and

a control procedure of replacing operation control information that is being held with operation control information that was received and, on the basis of the operation control information that follows replacement, controlling the operation of the supply/demand adjustment device.

### Effect of the invention

The present invention can prevent increase in the amount of communication processing when the number of power supply/demand adjustment devices becomes large.

### BRIEF DESCRIPTION OF THE DRAWINGS

FIG. 1 shows control device A of the first exemplary embodiment of the present invention.

FIG. 2 is a flow chart for describing the operation of control device A.

FIG. 3 shows control device B of the second exemplary embodiment of the present invention.

FIG. 4 is a flow chart for describing the operation of control device B.

FIG. 5 shows a power control system that includes control device C of the third exemplary embodiment of the present invention.

FIG. 6 shows an example of operation control information.

FIG. 7 is a flow chart for describing the transmission operation of power supply/demand adjustment device D.

FIG. 8 is a flow chart for describing the operation at the operation start time of control device C.

FIG. 9 is a flow chart for describing the operation that follows the operation start time of control device C.

FIG. 10 is a flow chart for describing the operation when power supply/demand adjustment device D receives operation control information.

FIG. 11A is a flow chart for describing the operation by which power supply/demand adjustment device D controls storage battery R2 on the basis of operation control information.

FIG. 11B shows another example of apparatus control device D1.

FIG. 12 shows power control system 1000 that includes the fourth exemplary embodiment of the present invention.

FIG. 13 shows an example of load-dispatching unit 2, power control device 7, and a plurality of apparatus control devices 8.

FIG. 14A shows an example of storage battery distribution ratio curve 202a during discharging.

FIG. 14B shows an example of storage battery distribution ratio curve 202b during charging.

FIG. 15A shows an example of the DR1 charge/discharge gain line.

FIG. 15B shows an example of the DR2 charge/discharge gain line.

FIG. 16 is a flow chart for describing the operation by which apparatus control device 8 determines usage information.

FIG. 17 is a sequence diagram for describing the P_{ES} derivation operation.

FIG. 18 is a sequence diagram for describing the DR1 comprehension operation.

FIG. 19 is a sequence diagram for describing the DR1 allotment operation.

FIG. 20 shows an example of first local charge/discharge gain line 800A.

FIG. 21 is a sequence diagram for describing the charging/discharging control operation.

FIG. 22 is a sequence diagram for describing the DR2 comprehension operation.

FIG. 23 is a sequence diagram for describing the DR2 allotment operation.

FIG. 24 shows an example of second local charge/discharge gain line 800B.

FIG. 25 is a sequence diagram for describing the charging/discharging control operation.

FIG. 26 shows the fourth exemplary embodiment, a modification of the fourth exemplary embodiment, and a comparative example.

### EXEMPLARY EMBODIMENT

Exemplary embodiments of the present invention are next described with reference to the accompanying drawings.

### First Exemplary Embodiment

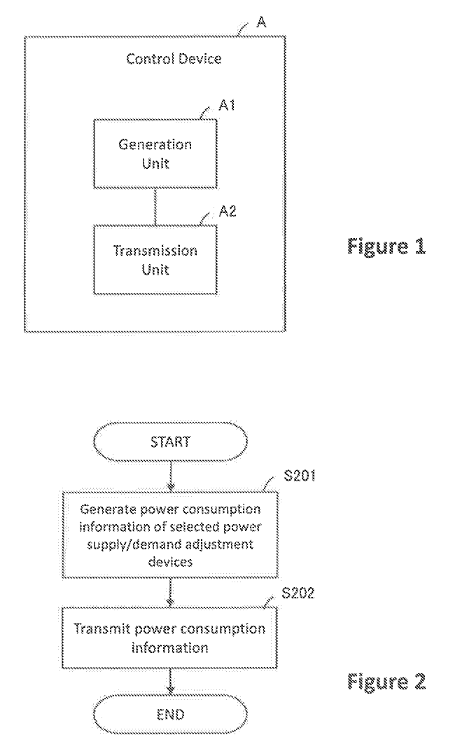

FIG. 1 shows control device A of the first exemplary embodiment of the present invention.

Control device A controls a plurality of power supply/demand adjustment devices that are connected to a power transmission and distribution network. The power transmission and distribution network is included in a power system.

Power supply/demand adjustment devices adjust the balance between the supply and demand of electric power in a power transmission and distribution network. A power supply/demand adjustment device, for example, controls its own device's power demand (power consumption) and power supply (for example, power discharge and generation) to adjust the balance between supply and demand of electric power in the power transmission and distribution network. The power supply/demand adjustment device may further be a device or apparatus that adjusts the balance between the supply and demand of electric power by controlling the amount of power demand without controlling the amount of power supply.

The power supply/demand adjustment device is, for example, a storage battery, an air conditioner, an electric water heater, a heat pump water heater, a pump, or a freezer. The power supply/demand adjustment device is not limited to a storage battery, air conditioner, electric water heater, heat-pump water heater, pump, or freezer, and can be selected as appropriate. For example, an electric vehicle may also be used as a power supply/demand adjustment device.

Control device A includes generation unit A1 and transmission unit A2.

Generation unit A1 generates electric power consumption information that instructs the power consumption of each of the portion of power supply/demand adjustment devices on the basis of the status information of the portion of power supply/demand adjustment devices that was received from the portion of a plurality of power supply/demand adjustment devices.

The portion of a plurality of power supply/demand adjustment devices refers to, for example, among E (where E is an integer equal to 2 or more) power supply/demand adjustment devices, F (where F is an integer equal to or greater than 1 but less than E) power supply/demand adjustment devices.

For example, generation unit A1 may use as the status information of a portion of power supply/demand adjustment devices, of the status information of each of E power supply/demand adjustment devices that is received from E power supply/demand adjustment devices, the status information of F power supply/demand adjustment devices that was received.

Alternatively, when the status information of only F power supply/demand adjustment devices was received within a predetermined interval, generation unit A1 may also use the status information of the F power supply/demand adjustment devices that was received as the status information of a portion of power supply/demand adjustment devices.

In the present exemplary embodiment, generation unit A1 uses as the status information of a portion of power supply/demand adjustment devices the status information of F power supply/demand adjustment devices that was received of the status information of each of E power supply/demand adjustment devices that was received from the E power supply/demand adjustment devices.

A detailed configuration that, when generation unit A1 has received the status information of only F power supply/demand adjustment devices within a predetermined time interval, uses the status information of the F power supply/demand adjustment devices that was received as the status information of a portion of the power supply/demand adjustment devices is described in the second exemplary embodiment that will be described later.

The electric power consumption information is an example of the operation control information for controlling the operation of power supply/demand adjustment devices.

When a power supply/demand adjustment device is a storage battery that is capable of charging/discharging, the maximum electric power consumption of the power supply/demand adjustment device refers to the maximum charging power, and the minimum electric power consumption of the power supply/demand adjustment device refers to the maximum discharging power.

The maximum electric power consumption and the minimum electric power consumption of a power supply/demand adjustment device can be offered as examples of the status information of a power supply/demand adjustment device.

Generation unit A1 places a plurality of power supply/demand adjustment devices under its control.

Generation unit A1 generates power consumption information of the portion of power supply/demand adjustment devices on the basis of, for example, the maximum electric power consumption of a portion of power supply/demand adjustment devices and the minimum electric power consumption of the portion of power supply/demand adjustment devices.

As an example, generation unit A1 distributes an allotted power consumption that has been assigned to control device A to the portion of power supply/demand adjustment devices within a range in which the power consumption of each of the portion of power supply/demand adjustment devices is equal to or less than the maximum electric power consumption of the portion of power supply/demand adjustment devices and equal to or greater than the minimum electric power consumption. Generation unit A1 generates power consumption information that shows the electric power consumption that has been distributed to the power supply/demand adjustment devices for each of the portion of power supply/demand adjustment devices.

Transmission unit A2 transmits each item of power consumption information that was generated by generation unit A1 to power supply/demand adjustment devices that accord with the power consumption information.

The operation of the present exemplary embodiment is next described.

FIG. 2 is a flow chart for describing the operation of control device A.

In the present exemplary embodiment, each of a plurality of power supply/demand adjustment devices is assumed to transmit its own device's status information (maximum electric power consumption and minimum electric power consumption) to control device A.

Generation unit A1 receives the status information of the power supply/demand adjustment devices from each power supply/demand adjustment device.

Generation unit A1 next, on the basis of among the status information of the plurality of power supply/demand adjustment devices, the status information of a number that is equal or less than a threshold value of power supply/demand adjustment devices (hereinbelow referred to as “selected power supply/demand adjustment devices”), generates power consumption information of the selected power supply/demand adjustment devices (Step S201).

The selected power supply/demand adjustment devices are an example of a portion of power supply/demand adjustment devices. The number represented by the threshold value is a number that is less than the number of the plurality of power supply/demand adjustment devices (the power supply/demand adjustment devices that are under the control of generation unit A1). Further, the number represented by the threshold value may be changed at any timing as long as the number is less than the number of the plurality of power supply/demand adjustment devices. The threshold value is held in generation unit A1.

In Step S201, generation unit A1 distributes the allotted electric power consumption of control device A to each selected power supply/demand adjustment device in which the electric power consumption of each selected power supply/demand adjustment device is within a range of equal to or less than the maximum electric power consumption of that selected power supply/demand adjustment device and equal to or greater than the minimum electric power consumption of that selected power supply/demand adjustment device.

Generation unit A1 next generates and sets power consumption information that shows the distributed electric power consumption for each selected power supply/demand adjustment device.

When the assigned electric power consumption of control device A is greater than the sum total of the maximum electric power consumption of selected power supply/demand adjustment devices, generation unit A1 generates, as the electric power consumption of each selected power supply/demand adjustment device, power consumption information that shows the maximum electric power consumption of each.

Generation unit A1 then supplies the power consumption information of each selected power supply/demand adjustment device to transmission unit A2.

Transmission unit A2, upon receiving the power consumption information of each selected power supply/demand adjustment device, transmits each item of power consumption information to the selected power supply/demand adjustment devices that accord with the power consumption information (Step S202).

Each selected power supply/demand adjustment device, upon receiving the power consumption information, consumes electric power at the electric power consumption that is indicated in the power consumption information. As a result, the operation of the selected power supply/demand adjustment devices is controlled by the power consumption information.

The effect of the present exemplary embodiment is next described.

In the present exemplary embodiment, generation unit A1 generates power consumption information of each of a portion of a plurality of power supply/demand adjustment devices on the basis of the maximum electric power consumption and minimum electric power consumption of the portion of the plurality of power supply/demand adjustment devices that were received from the portion of power supply/demand adjustment devices. Transmission unit A2 transmits each item of power consumption information to the power supply/demand adjustment devices that accord with the power consumption information.

As a result, transmission unit A2 is able to reduce the amount of communication processing that is needed to communicate power consumption information compared to a case in which transmission unit A2 transmits power consumption information to all of a plurality of power supply/demand adjustment devices.

In the present exemplary embodiment, moreover, generation unit A1 generates power consumption information of the portion of power supply/demand adjustment devices on the basis of, among the maximum electric power consumption and minimum electric power consumption that was received from a plurality of power supply/demand adjustment devices, the maximum electric power consumption and minimum electric power consumption of the portion of power supply/demand adjustment devices.

As a result, generation unit A1 is able to independently determine power supply/demand adjustment devices for which generation unit A1 generates power consumption information.

A modification of the present exemplary embodiment is next described.

Each of a plurality of power supply/demand adjustment devices may transmit its own device's maximum electric power consumption and minimum electric power consumption at period Ta. In this case, generation unit A1 may generate power consumption information of the portion of power supply/demand adjustment devices at period Ta on the basis of, among the maximum electric power consumption and minimum electric power consumption of the plurality of power supply/demand adjustment devices that was received in an interval of period Ta, the maximum electric power consumption and minimum electric power consumption of the portion of power supply/demand adjustment devices. Period Ta is, for example, 10 seconds. However, period Ta is not limited to 10 seconds and can be altered as appropriate.

In addition, generation unit A1 may also switch the selected power supply/demand adjustment devices upon executing the operation of generating power consumption information of selected power supply/demand adjustment devices a predetermined number of times (for example, one time). The predetermined number of times is not limited to one time and can be altered as appropriate. In this case, the continuous selection of a portion of power supply/demand adjustment devices as selected power supply/demand adjustment devices can be prevented.

Still further, generation unit A1 preferably gives priority to the selection, as selected power supply/demand adjustment devices, of power supply/demand adjustment devices that have not been selected as selected power supply/demand adjustment devices for a lengthy interval. In this case, variation in the intervals up to which power supply/demand adjustment devices are selected as a selected power supply/demand adjustment devices can be reduced.

Further, to maintain fairness, generation unit A1 may also select power supply/demand adjustment devices that are not selected as selected power supply/demand adjustment devices (hereinbelow referred to as “non-object power supply/demand adjustment devices) in sequence on the basis of characteristic identification numbers that have been set in advance such as the manufacturing number of the power supply/demand adjustment devices.

Still further, generation unit A1 may also select non-object power supply/demand adjustment devices on the basis of the amount of electric power consumption up to the present rather than the interval of non-selection as a selected power supply/demand adjustment device, or may select non-object power supply/demand adjustment devices on the basis of not only that interval, but also on the basis of the amount of electric power consumption up to the present.

For example, generation unit A1 may select, as a non-object power supply/demand adjustment device, a power supply/demand adjustment device in which the amount of electric power consumption up to the present is relatively great.

### Second Exemplary Embodiment

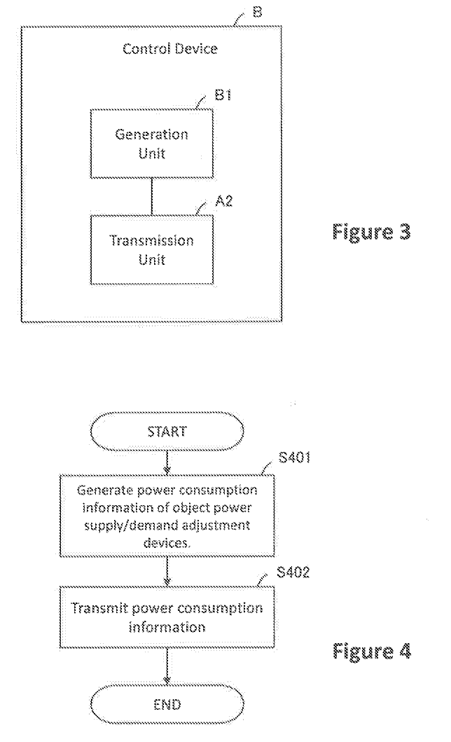

FIG. 3 shows control device B of the second exemplary embodiment of the present invention. In FIG. 3, constituent elements that are identical to elements shown in FIG. 1 are given the same reference numbers.

Control device B controls a plurality of power supply/demand adjustment devices that are connected to a power transmission and distribution network. Similar to control device A, control device B includes generation unit B1 and transmission unit A2.

In the first exemplary embodiment, generation unit A1 used, as the status information of a portion of a plurality of power supply/demand adjustment devices, the status information of the portion of power supply/demand adjustment devices among the status information that was received from the plurality of power supply/demand adjustment devices.

In the second exemplary embodiment, in contrast, when at least any one item of status information has not been received from a plurality of power supply/demand adjustment devices within a predetermined interval, generation unit B1 uses the status information of the power supply/demand adjustment devices that was received in the predetermined interval as the status information of the portion of power supply/demand adjustment devices.

In this exemplary embodiment as well, the maximum electric power consumption and minimum electric power consumption of power supply/demand adjustment devices are used as the status information of the power supply/demand adjustment devices.

Generation unit B1, similar to generation unit A1, places a plurality of power supply/demand adjustment devices under its control. For example, generation unit B1 holds identification information of a plurality of power supply/demand adjustment devices.

Generation unit B1 generates power consumption information of a portion of power supply/demand adjustment devices on the basis of the maximum electric power consumption of the portion of power supply/demand adjustment devices and the minimum electric power consumption of the portion of power supply/demand adjustment devices.

The method of generating the power consumption information in generation unit B1 is the same as the method of generating power consumption information in generation unit A1.

Transmission unit A2 transmits each item of power consumption information that was generated in generation unit B1 to power supply/demand adjustment devices that accord with the power consumption information.

The operation of the present exemplary embodiment is next described.

FIG. 4 is a flow chart for describing the operation of control device B.

In the present exemplary embodiment, each of a plurality of power supply/demand adjustment devices is assumed to transmit its own device's status information (the maximum electric power consumption and minimum electric power consumption) to control device B. In addition, each of the plurality of power supply/demand adjustment devices transmits its own device's status information and identification information to control device B.

At this time, the possibility exists that status information of a power supply/demand adjustment device will not reach control device B due to a communication error or a problem in the power supply/demand adjustment device itself.

When status information has not been received for all of the plurality of power supply/demand adjustment devices within a predetermined interval (for example, 10 seconds), generation unit B1 uses the status information of the power supply/demand adjustment devices that was received within the predetermined interval as the status information of the portion of power supply/demand adjustment devices. A power supply/demand adjustment device that accords with status information that was received within the predetermined interval is hereinbelow referred to as an “object power supply/demand adjustment device”. The predetermined interval is not limited to 10 seconds and can be altered as appropriate. Here, when generation unit B1 has not received the identification information of all of the plurality of power supply/demand adjustment devices, generation unit B1 determines within a predetermined interval that the status information has not been received from all of the plurality of power supply/demand adjustment devices.

Generation unit B1 next generates power consumption information of the object power supply/demand adjustment devices on the basis of the status information of the object power supply/demand adjustment devices (Step S401).

At this time, generation unit B1 distributes the assigned electric power consumption that has been assigned to control device B to each object power supply/demand adjustment device such that the electric power consumption of each object power supply/demand adjustment device is within a range that is equal to or less than the maximum electric power consumption and equal to or greater than the minimum electric power consumption of the object power supply/demand adjustment device.

Generation unit B1 then generates power consumption information that indicates the distributed electric power consumption for each object power supply/demand adjustment device.

When the assigned electric power consumption of control device B is greater than the sum total of the maximum electric power consumption of the object power supply/demand adjustment devices, generation unit B1 generates, as the electric power consumption of each object power supply/demand adjustment device, power consumption information that indicates the maximum electric power consumption of each power supply/demand adjustment device.

Generation unit B1 next supplies the power consumption information of each object power supply/demand adjustment device to transmission unit A2.

Transmission unit A2, having received the power consumption information of each object power supply/demand adjustment device, transmits each item of power consumption information to the object power supply/demand adjustment device that accords with the power consumption information (Step S402).

Each object power supply/demand adjustment device, having received the power consumption information, consumes electric power at the electric power consumption that is indicated in the power consumption information.

The effect of the present exemplary embodiment is next described.

In the present exemplary embodiment, when the maximum electric power consumption and minimum electric power consumption of all of a plurality of power supply/demand adjustment devices have not been received within a predetermined interval, generation unit B1 uses the maximum electric power consumption and minimum electric power consumption of the power supply/demand adjustment devices that were received within the predetermined interval as the maximum electric power consumption and minimum electric power consumption of a portion of power supply/demand adjustment devices.

As a result, even when the maximum electric power consumption and minimum electric power consumption of all of a plurality of power supply/demand adjustment devices could not be received within a predetermined interval, power consumption information of a portion of power supply/demand adjustment devices can be generated on the basis of the maximum electric power consumption and minimum electric power consumption of that portion of power supply/demand adjustment devices.

Modifications of the first and second exemplary embodiments are next described.

In the first and second exemplary embodiments, the maximum electric power consumption and minimum electric power consumption of a power supply/demand adjustment device were used as the status information of the power supply/demand adjustment device, but the SOC (State of Charge) may also be used as the status information of the power supply/demand adjustment device when the power supply/demand adjustment device is a storage battery.

In this case, assuming that each power supply/demand adjustment device has the same configuration, generation unit A1 of the first exemplary embodiment and generation unit B1 of the second exemplary embodiment operate as shown below.

Generation unit A1 increases the value of the electric power consumption that is distributed to a selected power supply/demand adjustment device in inverse proportion to the level of the SOC of the selected power supply/demand adjustment device. Generation unit B1 also increases the value of the electric power consumption that is distributed to an object power supply/demand adjustment device in inverse proportion to the level of the SOC of the object power supply/demand adjustment device.

### Third Exemplary Embodiment

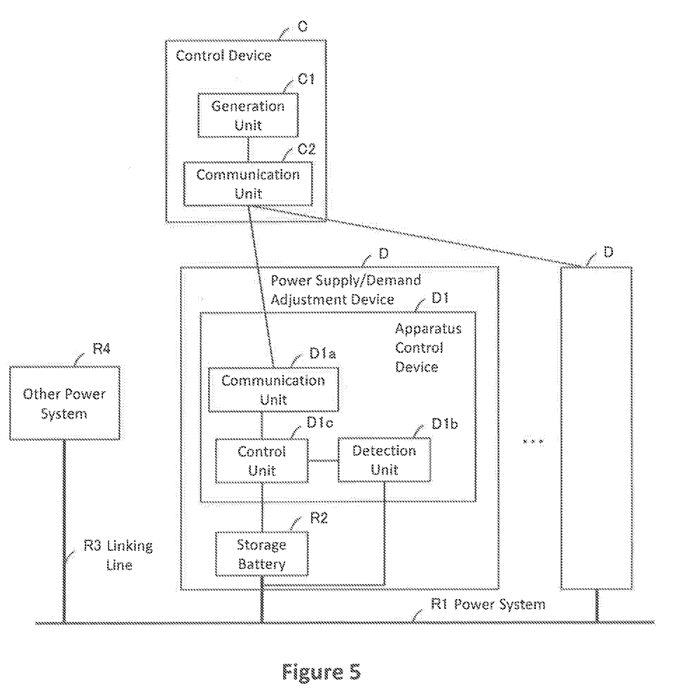

FIG. 5 shows a power control system that includes control device C of the third exemplary embodiment of the present invention.

An outline of the power control system is first described.

The power control system includes control device C and a plurality of power supply/demand adjustment devices D.

Control device C controls the plurality of power supply/demand adjustment devices that are connected to power system R1. Control device C places the plurality of power supply/demand adjustment devices D under its control. For example, control device C holds the identification information of the plurality of power supply/demand adjustment devices D. Power system R1 is connected to another power system R4 by way of linking line R3.

Power supply/demand adjustment devices D adjust the balance between supply and demand of electric power in power system R1. Power supply/demand adjustment devices D adjust the balance between electric power supply and demand in power system R1 by, for example, controlling the power demand (electric power consumption) and power supply (for example, discharging) in storage batteries R2.

Each power supply/demand adjustment device D transmits the chargeable/dischargeable capacity of storage battery R2 to control device C at period T1 (for example, 15 minutes). The “chargeable/dischargeable capacity of storage battery R2” may hereinbelow be referred to as simply the “chargeable/dischargeable capacity”. At this time, power supply/demand adjustment device D transmits its own device's identification information together with the chargeable/dischargeable capacity to control device C.

The chargeable/dischargeable capacity is one example of the status information of power supply/demand adjustment device D. The chargeable/dischargeable capacity may be, for example, the capacity of a storage battery that is offered by the owner of storage battery R2 by way of a contract or may be specified according to the SOC of storage battery R2.

As the method of specifying the chargeable/dischargeable capacity according to the SOC of storage battery R2, a method may be used in which, for example, a table that indicates the correspondence relation between the SOC in storage battery R2 and the chargeable/dischargeable capacity is used to specify the chargeable/dischargeable capacity based on the SOC. This table may be held in, for example, control unit D1c in power supply/demand adjustment device D. As this table, a table may be used that indicates a relation in which the chargeable/dischargeable capacity reaches a maximum when the SOC is 0.5 and the chargeable/dischargeable capacity decreases as the SOC increases distance from 0.5.

When control device C receives chargeable/dischargeable capacity and identification information from power supply/demand adjustment device D, control device C holds the reception results.

Control device C executes different operations at the operation start time and after the start time.

The operation at the operation start time of control device C is first described.

If control device C has received the chargeable/dischargeable capacity from all power supply/demand adjustment devices D that are under its control, at the operation start time, control device C generates operation control information for controlling the operation of power supply/demand adjustment devices D (hereinbelow referred to as simply “operation control information”) for each power supply/demand adjustment device D on the basis of each item of chargeable/dischargeable capacity. If the identification information of all power supply/demand adjustment devices D under its control has been received together with the chargeable/dischargeable capacity, control device C determines that the chargeable/dischargeable capacity has been received from all power supply/demand adjustment devices D under its control.

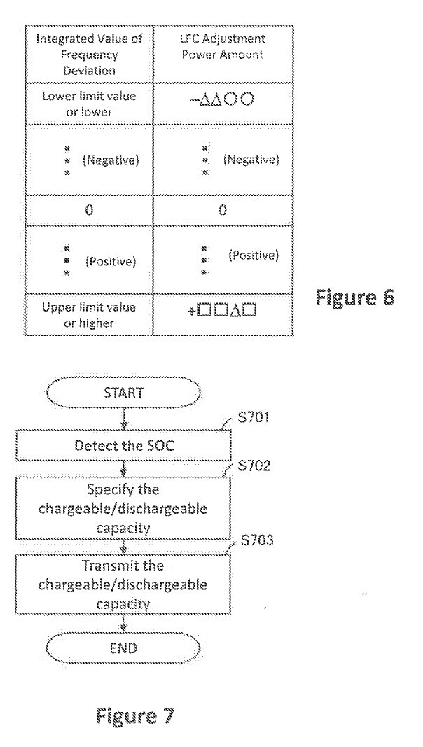

FIG. 6 shows an example of the operation control information.

The operation control information shown in FIG. 6 shows the relation between the integrated value of the frequency deviation of the electric power in power system R1 (hereinbelow referred to as simply “frequency deviation”) and the adjustment power amount in storage battery R2 (the LFC (Load Frequency Control) adjustment power amount).

This operation control information is operation control information for causing power supply/demand adjustment devices D to execute an LFC adjustment process.

A positive-value adjustment power amount indicates charging of storage battery R2. A negative-value adjustment power amount indicates discharging of storage battery R2. The frequency deviation is calculated using the formula “frequency of the electric power of power system R1”−“reference frequency of electric power of power system R1 (for example, 50 Hz)”. The reference frequency of the electric power of power system R1 is stored in control unit D1c in apparatus control device D1.

Control device C generates operation control information such that, for example, the adjustment power amount of storage battery R2 (see FIG. 6) is no greater than the chargeable/dischargeable capacity of storage battery R2.

Control device C transmits each item of operation control information to the corresponding power supply/demand adjustment device D.

The operation that follows the operation start time of control device C is next described.

Control device C executes the following operation after period T1 (for example, 15 minutes) following execution of the operation at the operation start time.

On the basis of the chargeable/dischargeable capacity of, of the plurality of power supply/demand adjustment devices D, a portion of the power supply/demand adjustment devices (hereinbelow referred to as “processing-object power supply/demand adjustment devices”) D, control device C generates operation control information of the processing-object power supply/demand adjustment devices D.

For example, when unable to receive the chargeable/dischargeable capacity from all power supply/demand adjustment devices D during period T1, control device C uses the chargeable/dischargeable capacity from power supply/demand adjustment devices D that could be received during period T1 as the chargeable/dischargeable capacity from processing-object power supply/demand adjustment devices D. Control device C here determines that the chargeable/dischargeable capacity could not be received from all power supply/demand adjustment devices D during period T1 when the identification information of all power supply/demand adjustment devices D that are under its control could not be received together with the chargeable/dischargeable capacity.

Further, control device C carries out the same operation as at the operation start time when able to receive the chargeable/dischargeable capacity from all power supply/demand adjustment devices D during period T1.

The operation in which control device C generates operation control information of processing-object power supply/demand adjustment devices D on the basis of the chargeable/dischargeable capacity of the processing-object power supply/demand adjustment devices D is next described.

Control device C first determines the chargeable/dischargeable capacity of power supply/demand adjustment devices (hereinbelow referred to as “non-processing-object power supply/demand adjustment devices”) D except for power supply/demand adjustment devices D that are the objects of processing.

In the present exemplary embodiment, control device C uses the most recent chargeable/dischargeable capacity among the chargeable/dischargeable capacity of the non-processing-object power supply/demand adjustment devices D that was received in the past as the chargeable/dischargeable capacity of the non-processing-object power supply/demand adjustment devices D at that time.

Control device C recognizes the chargeable/dischargeable capacity of all power supply/demand adjustment devices D by reusing the past chargeable/dischargeable capacity of non-processing-object power supply/demand adjustment devices D.

Further, control device C may also use a value that has been set in advance (such as a default value) as the chargeable/dischargeable capacity of non-processing-object power supply/demand adjustment devices D.

Control device C, having recognized the chargeable/dischargeable capacity of all power supply/demand adjustment devices D, generates operation control information for each power supply/demand adjustment device D by the same method as the generation method of operation control information at the operation start time.

Control device C, having generated operation control information for each power supply/demand adjustment device D, transmits the operation control information of these processing-object power supply/demand adjustment devices D to processing-object power supply/demand adjustment devices D. At this time, control device C does not transmit operation control information to non-processing-object power supply/demand adjustment devices D. As a result, the amount of communication processing of operation control information in control device C can be reduced compared to a case in which operation control information is transmitted to non-processing-object power supply/demand adjustment devices D.

The method of generating operation control information that is executed by control device C as described above is executed by generation unit C1 (to be described).

Upon receiving operation control information, power supply/demand adjustment devices D (for example, control unit D1c to be described hereinbelow) holds this operation control information. If, at the time of receiving the operation control information, power supply/demand adjustment device D (for example, control unit D1c) holds operation control information that was received previously, it replaces this operation control information that is being held with the newly received operation control information. This substitution refers to “overwrite saving” or “replacement holding.”

Power supply/demand adjustment device D, having held the newly received operation control information, detects the frequency of the electric power of power system R1 at period T2 that is shorter than period T1. Period T1 is, for example, from several minutes to between ten and nineteen minutes (such as 15 minutes). Period T2 is, for example, from 0.5 seconds to 1 second.

Power supply/demand adjustment device D (for example, control unit D1c) uses the formula “frequency of electric power of power system R1”−“reference frequency of electric power of power system R1” to calculate the frequency deviation. Power supply/demand adjustment device D (for example, control unit D1c) next calculates the integrated value of the frequency deviation.

Power supply/demand adjustment device D (for example, control unit D1c) uses the operation control information that is being held (refer to FIG. 6) to specify the adjustment power amount that corresponds to the integrated value of the frequency deviation (hereinbelow referred to as “corresponding adjustment power amount”).

Power supply/demand adjustment device D controls the charging or discharging of storage battery R2 at the corresponding adjustment power amount. The LFC adjustment process is executed by this control.

Further, when period T1 that was set in advance elapses without power supply/demand adjustment device D (for example, control unit D1c) transmitting the chargeable/dischargeable capacity, power supply/demand adjustment device D (for example, control unit D1c) controls the operation of storage battery R2 at period T2 on the basis of the past operation control information that is being held in power supply/demand adjustment device D (for example, control unit D1c) and the integrated value of the frequency deviation. Here, circumstances in which power supply/demand adjustment device D (for example, control unit D1c) does not transmit chargeable/dischargeable capacity include a state in which power supply/demand adjustment device D (for example, control unit D1c) intentionally does not transmit the chargeable/dischargeable capacity and a state in which the chargeable/dischargeable capacity is unintentionally not (cannot be) transmitted due to some unintended fault.

Alternatively, when power supply/demand adjustment device D (for example, control unit D1c) has transmitted the chargeable/dischargeable capacity but this chargeable/dischargeable capacity does not arrive at control device C and new operation control information is not received despite the passage of period T1 that was set in advance, power supply/demand adjustment device D (for example, control unit D1c) controls the operation of storage battery R2 at period T2 on the basis of past operation control information that was held in power supply/demand adjustment device D (for example, control unit D1c) and the integrated value of the frequency deviation.

The detection operation of the state (frequency) of power system R1 is executed by detection unit D1b that will be described later. In addition, the operation of controlling the operation of storage battery R2 on the basis of the operation control information and integrated value of the frequency deviation in power system R1 is executed by control unit D1c.

Details of the power control system are next described.

Control device C is first described.

Control device C includes generation unit C1 and communication unit C2.

Communication unit C2 is an example of the transmission unit. Communication unit C2 communicates with each power supply/demand adjustment device D. For example, communication unit C2 receives chargeable/dischargeable capacity from power supply/demand adjustment devices D. In addition, communication unit C2 transmits operation control signals to power supply/demand adjustment devices D.

Generation unit C1 generates operation control information of power supply/demand adjustment devices D on the basis of the chargeable/dischargeable capacity of power supply/demand adjustment devices D. The method of generating this operation control information is similar to the method by which above-described control device C generates operation control information.

Power supply/demand adjustment devices D are next described.

Power supply/demand adjustment device D includes apparatus control device D1 and storage battery R2. Power supply/demand adjustment device D also functions as, for example, a storage device. Apparatus control device D1 is an example of the control device. Apparatus control device D1 includes communication unit D1a, detection unit D1b, and control unit D1c.

Communication unit D1a is an example of the communication means. Communication unit D1a communicates with control device C. For example, communication unit D1a transmits the chargeable/dischargeable capacity of storage battery R2 together with identification information to control device C. In addition, communication unit D1a also receives operation control information from control device C. Control device C is an example of an external device.

Detection unit D1b is an example of the detection means. Detection unit D1b detects the frequency (the system frequency) of the electric power of power system R1.

Control unit D1c is an example of the control means. Control unit D1c controls apparatus control device D1 and storage battery R2. For example, control unit D1c uses the detection result of detection unit D1b to calculate the integrated value of the frequency deviation.

Control unit D1c further controls the operation (charging and discharging) of storage battery R2 on the basis of operation control information and the integrated value of the frequency deviation. This method of controlling the operation of storage battery R2 is similar to the method by which power supply/demand adjustment device D controls the operation of storage battery R2.

The operation of the present exemplary embodiment is next described.

The operation by which power supply/demand adjustment device D transmits chargeable/dischargeable capacity is first described.

FIG. 7 is a flow chart for describing the operation by which power supply/demand adjustment device D transmits chargeable/dischargeable capacity.

In power supply/demand adjustment device D, control unit D1c detects the SOC of storage battery R2 (Step S701).

Control unit D1c next uses a table that shows the correspondence relation between the SOC in storage battery R2 and the chargeable/dischargeable capacity to specify the chargeable/dischargeable capacity based on the SOC (Step S702). This table is assumed to be held in advance in control unit D1c.

Control unit D1c next transmits the chargeable/dischargeable capacity together with its own device's identification information from communication unit D1a to control device C2 (Step S703).

Control unit D1c repeats the series of operations of Step S701-S703 at period T1.

The operation at the operation start time of control device C is next described.

FIG. 8 is a flow chart for describing the operation at the operation start time of control device C.

In control device C, communication unit C2, upon receiving the chargeable/dischargeable capacity and identification information from each power supply/demand adjustment device D, supplies the chargeable/dischargeable capacity and identification information to generation unit C1.

Generation unit C1, having received the chargeable/dischargeable capacity of all power supply/demand adjustment devices D that are under the control of control device C, generates operation control information for each power supply/demand adjustment device D on the basis of the chargeable/dischargeable capacity (Step S801) of each device D. When generation unit C1 has here received the identification information of all power supply/demand adjustment devices D that are under the control of control device C, generation unit C1 determines that the chargeable/dischargeable capacity of all power supply/demand adjustment devices D under the control of control device C has been received.

This operation control information shows the relation between the integrated value of the frequency deviation and the adjustment power amount in storage battery R2 in power supply/demand adjustment device D (see FIG. 6).

In Step S801, generation unit C1 generates operation control information such that for each power supply/demand adjustment device D, the absolute value of the adjustment power amount (see FIG. 6) of storage battery R2 in power supply/demand adjustment device D is no greater than the chargeable/dischargeable capacity of that storage battery R2.

Generation unit C1 further increases the maximum value of the absolute value of the adjustment power amount in the operation control information in proportion to the magnitude of the chargeable/dischargeable capacity in power supply/demand adjustment device D.

Still further, generation unit C1 changes the operation control information according to adjustment amount information that relates to the power adjustment amount (for example, a power adjustment amount entrusted from a power company or a power adjustment amount that was successfully bid on the electric power market) undertaken by control device C. For example, generation unit C1 generates operation control information for each power supply/demand adjustment device D such that the total amount of the adjustment power amount (see FIG. 6) of each storage battery R2 in the integrated value of a particular frequency deviation coincides with the power adjustment amount that was undertaken by control device C for the integrated value of that frequency deviation.

Generation unit C1 then causes communication unit C2 to execute the process of transmitting to each power supply/demand adjustment device D the operation control information corresponding to that power supply/demand adjustment device D (Step S802).

The operation after the operation start time of control device C is next described.

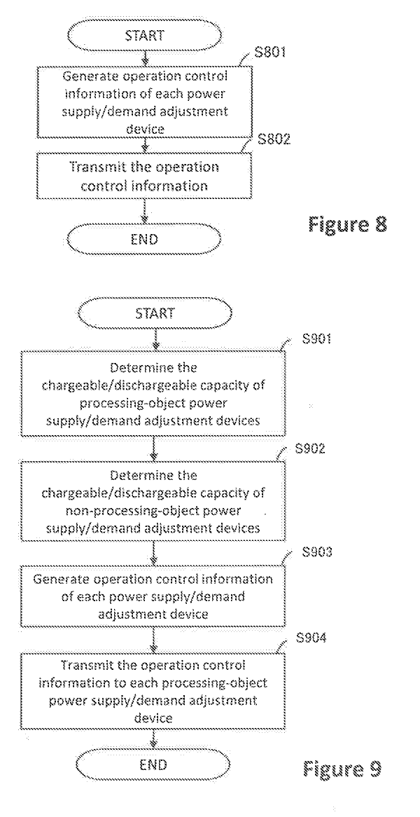

FIG. 9 is a flow chart for describing the operation after the operation start time of control device C.

Generation unit C1 executes the operation that follows the operation start time shown below at period T1 after having executed the operation of the above-described operation start time.

When unable to receive the chargeable/dischargeable capacity from all power supply/demand adjustment devices D during a current period T1, generation unit C1 determines the chargeable/dischargeable capacity of power supply/demand adjustment devices D for which reception was achieved during the current period T1 as the chargeable/dischargeable capacity of the objects of processing (Step S901). Here, when unable to receive the identification information together with the chargeable/dischargeable capacity of all power supply/demand adjustment devices D that are under control during the current period T1, generation unit C1 determines that the chargeable/dischargeable capacity could not be received from all power supply/demand adjustment devices D during the current period T1.

Generation unit C1 operates similarly to the operation start time when the chargeable/dischargeable capacity could be received from all power supply/demand adjustment devices D during the current period T1.

Generation unit C1 next determines the most recent chargeable/dischargeable capacity among the chargeable/dischargeable capacity of non-processing-object power supply/demand adjustment devices D that was received in the past as the chargeable/dischargeable capacity of non-processing-object power supply/demand adjustment devices D at that time (Step S902). The non-processing-object power supply/demand adjustment devices D are power supply/demand adjustment devices D except for the processing-object power supply/demand adjustment devices D.

In Step S901 and Step S902, generation unit C1 recognizes the chargeable/dischargeable capacity of all power supply/demand adjustment devices D.

Upon recognizing the chargeable/dischargeable capacity of all power supply/demand adjustment devices D, generation unit C1 generates operation control information for each power supply/demand adjustment device D by a method (see Step S801) similar to the method of generating operation control information at the operation start time (Step S903).

Generation unit C1 may also generate each item of operation control information by using the chargeable/dischargeable capacity of processing-object power supply/demand adjustment devices D without using the chargeable/dischargeable capacity of non-processing-object power supply/demand adjustment devices D.

In this case, generation unit C1 generates operation control information for each processing-object power supply/demand adjustment device D such that the absolute value of the adjustment power amount (see FIG. 6) in storage battery R2 in processing-object power supply/demand adjustment device D is no greater than the chargeable/dischargeable capacity of that storage battery R2.

Further, generation unit C1 increases the maximum value of the absolute value of the adjustment power amount in the operation control information in proportion to the magnitude of the chargeable/dischargeable capacity of the processing-object power supply/demand adjustment device D.

Still further, generation unit C1 changes operation control information according to adjustment amount information that relates to the power adjustment amount undertaken by control device C. For example, generation unit C1 generates operation control information for each processing-object power supply/demand adjustment device D such that the total amount of the adjustment power amount (see FIG. 6) in storage battery R2 in each processing-object power supply/demand adjustment device D at the integrated value of a particular frequency deviation coincides with the power adjustment amount undertaken by control device C for that integrated value of frequency deviation.

Generation unit C1 next causes communication unit C2 to execute the process of transmitting to processing-object power supply/demand adjustment devices D the operation control information that accords with these processing-object power supply/demand adjustment devices D (Step S904).

The operation when power supply/demand adjustment device D has received operation control information is next described.

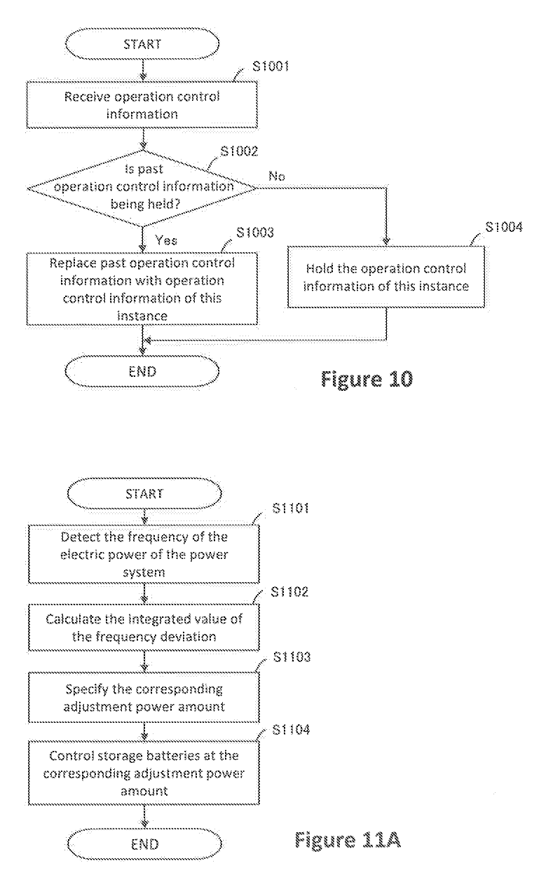

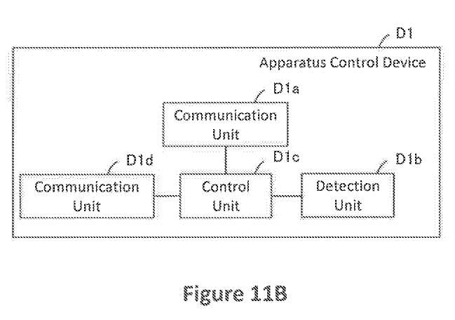

FIG. 10 is a flow chart for describing the operation when power supply/demand adjustment device D has received operation control information.

Communication unit D1a, upon receiving operation control information (Step S1001), supplies the operation control information to control unit D1c.

Control unit D1c, having received the operation control information, judges whether operation control information that was received in the past is being held (Step S1002).

When operation control information that was received in the past is being held, control unit D1c replaces the operation control information that was received in the past with the operation control information that was received this time (Step S1003). By executing Step S1003, control unit D1c deletes the operation control information that was received in the past and holds the operation control information that was received this time.

On the other hand, if operation control information that was received in the past is not being held, control unit D1c holds the operation control information that was received this time (Step S1004).

The operation in which power supply/demand adjustment device D controls storage battery R2 on the basis of the operation control information is next described.

FIG. 11A is a flow chart for describing the operation in which power supply/demand adjustment device D controls storage battery R2 on the basis of operation control information.

Apparatus control device D1 in power supply/demand adjustment device D repeats the operation shown below at period T2.

Detection unit D1b detects the frequency of the electric power of power system R1 (Step S1101). Detection unit D1b then supplies the frequency of the electric power of power system R1 to control unit D1c.

Control unit D1c, having received the frequency of the electric power of power system R1, calculates the frequency deviation using the formula “frequency of electric power of power system R1”−“reference frequency of electric power of power system R1” (Step S1102).

Control unit D1c next uses the operation control information that is being held (see FIG. 6) to specify the adjustment power amount (corresponding adjustment power amount) that corresponds to the integrated value of the frequency deviation (Step S1103).

Control unit D1c next controls the charging or discharging of storage battery R2 at the corresponding adjustment power amount (Step S1104).

The effect of the present exemplary embodiment is next described.

Generation unit C1 generates operation control information that shows the relation between the integrated value of frequency deviation and the adjustment power amount in storage batteries R2 in processing-object power supply/demand adjustment devices D for processing-object power supply/demand adjustment devices D at period T1 on the basis of the chargeable/dischargeable capacity that accords with the SOC of these storage batteries R2. Communication unit C2 transmits this operation control information to processing-object power supply/demand adjustment devices D at period T1.

As a result, processing-object power supply/demand adjustment devices D for which the most recent chargeable/dischargeable capacity has reached at generation unit C1 are able to control the operation of storage batteries R2 at period T2 on the basis of operation control information that accords with the most recent chargeable/dischargeable capacity and the integrated value of the frequency deviation. Because the operation control information corresponds to the most recent chargeable/dischargeable capacity, the operation of storage batteries R2 can be controlled with high accuracy.

On the other hand, non-processing-object power supply/demand adjustment devices D for which the most recent chargeable/dischargeable capacity has not been reported to generation unit C1 control the operation of storage batteries R2 at period T2 on the basis of operation control information that was received in the past and on the basis of the integrated value of the frequency deviation. In this case, change in the SOC of storage batteries R2 is not as rapid as the change of the integrated value of the frequency deviation, whereby the operation of storage batteries R2 can be controlled at a certain level of accuracy despite the use of operation control information that was received in the past.

A modification of the present exemplary embodiment is next described.

After the operation start time of control device C, generation unit C1 carries out operation similar to the operation of the operation start time when the chargeable/dischargeable capacity could be received from all power supply/demand adjustment devices D during period T1.

In contrast, generation unit C1 and communication unit C2 may also operate as shown below.

After the operation start time of control device C, when the chargeable/dischargeable capacity could be received from all power supply/demand adjustment devices D during period T1, generation unit C1 generates operation control information of a portion of these power supply/demand adjustment devices D on the basis of the chargeable/dischargeable capacity of this portion.

Communication unit C2 transmits the operation control information to the portion of power supply/demand adjustment devices D without transmitting operation control information to power supply/demand adjustment devices D except for the portion.

For example, when generation unit C1 is able to receive the chargeable/dischargeable capacity from all power supply/demand adjustment devices D during period T1, generation unit C1 may determine, among all power supply/demand adjustment devices D, power supply/demand adjustment devices D that is no greater than a predetermined threshold value as processing-object power supply/demand adjustment devices D.

In this case, generation unit C1 may use the chargeable/dischargeable capacity that was received within the current period T1 as the chargeable/dischargeable capacity of non-processing-object power supply/demand adjustment devices D, or may use the most recent chargeable/dischargeable capacity among the chargeable/dischargeable capacity of non-processing-object power supply/demand adjustment devices D that was received in the past.

In this case, the amount of communication processing of operation control information by communication unit C2 can be reduced even in cases in which the chargeable/dischargeable capacity can always be received from all power supply/demand adjustment devices D in each period T1.

Further, in this case, control units D1c of non-processing-object power supply/demand adjustment devices D cannot receive new operation control information despite the passage of period T1 that was set in advance from the transmission of the chargeable/dischargeable capacity. In this case, control units D1c of non-processing-object power supply/demand adjustment devices D control the operation of storage batteries R2 at period T2 on the basis of past operation control information that was saved in control unit D1c and the integrated value of the frequency deviation.

In the present exemplary embodiment (including the modification), power supply/demand adjustment devices D controlled storage batteries R2 on the basis of operation control information and the integrated value of frequency deviation, but power supply/demand adjustment devices D may also use an index that is determined on the basis of the frequency deviation and the power flow of power line R3 in place of the integrated value of the frequency deviation. As the operation control information in this case, operation control information is used that shows the relation between the index and the adjustment power amount in storage batteries R2 in processing-object power supply/demand adjustment devices D. For example, the column of the integrated value of the frequency deviation shown in FIG. 6 becomes the column of the index. The index is an example of an index that relates to the adjustment power amount.

The index is generated by a predetermined device (for example, a load-dispatching unit or control device C) at period T2.

The index is determined, for example, as shown below.

(A) When electric power is supplied from power system R1 to another power system R4 by way of linking line R3:

The electric power that is supplied from power system R1 to another power system R4 by way of linking line R3 is multiplied by a predetermined coefficient (positive value). The integrated value of the addition value of the result of this multiplication and the frequency deviation is determined as the index. The addition value refers to a corrected frequency deviation that results from correcting the frequency deviation by the power flow in linking line R3.

(B) When electric power is supplied from another power system R4 to power system R1 by way of linking line R3:

The electric power that is supplied from another power system R4 to power system R1 by way of linking line R3 is multiplied by the above-described predetermined coefficient. The integrated value of a value obtained by subtracting this multiplication result from the frequency deviation is determined as the index. The subtraction value refers to a corrected frequency deviation that results from correcting the frequency deviation by the power flow in linking line R3.

A predetermined device uses one-way communication or bidirectional communication (for example, one-to-N bidirectional communication) to transmit this index to each power supply/demand adjustment device D for each generation of the index at period T2.

In each power supply/demand adjustment device D, communication unit D1a uses one-way communication or bidirectional communication (for example, 1-to-N bidirectional communication) to receive and comprehend the index. Communication unit D1a supplies the received index to control unit D1c. In this case, communication unit D1a also serves as a comprehension means.

A communication unit that differs from communication unit D1a may also use one-way communication or bidirectional communication (for example, one-to-N bidirectional communication) to receive and comprehend the index.

FIG. 11B is a view showing an example of apparatus control device D1 in which communication unit D1d that differs from communication unit D1a uses one-way communication or bidirectional communication (for example, 1-to-N bidirectional communication) to receive and comprehend the index. In FIG. 11B, constituent elements that are identical to elements shown in FIG. 5 are given the same reference numbers. Communication unit D1d is an example of the comprehension means.

Control unit D1c repeats the following operation at period T2.

Control unit D1c, upon receiving an index from communication unit D1a, uses the operation control information that it holds to specify the adjustment power amount (corresponding adjustment power amount) that corresponds to the index.

Control unit D1c next controls the charging or discharging of storage battery R2 at the corresponding adjustment power amount.

The index is information that cannot be acquired despite checking power system R1. Apparatus control device D1 is able to acquire the index that cannot be obtained despite checking power system R1 by receiving an index that is transmitted from a predetermined device.

In addition, the index reflects the power flow of linking line R3. As a result, the accuracy of the information corresponding to the supply/demand adjustment amount of the entire power system is higher for the index than the integrated value of the frequency deviation. Accordingly, power supply/demand adjustment can be carried out with good accuracy.

Control unit D1c receives operation control information at period T1 (15 minutes), receives the index at period T2 (0.5-1 second), and uses the received operation control information to charge/discharge storage battery R2 at an adjustment power that corresponds to the index.

At this time, assuming that the index is A and the operation control information is B, power supply/demand adjustment device D receives A at an interval of T2 and receives A and B at an interval of T1 as shown below.

A, A, A . . . A, A, A+B, A, A, . . . , A, A, A+B

The amount of information in index (A) is small compared to operation control information (B), and index (A) can therefore be transmitted to each power supply/demand adjustment device at the short interval of period T2.

In the present exemplary embodiment (including the modification), a device or apparatus (such as an air conditioner, electric water heater, heat pump water heater, pump, freezer, or electric vehicle) may also be used in place of storage battery R2 for adjusting the balance between supply and demand of electric power by adjusting the amount of electric power demand. In this case, the consumable capacity of electric power should be used in place of the chargeable/dischargeable capacity.

Further, in the present exemplary embodiment (including the modification), a renewable energy source that is provided with an output-limiting function such as a photovoltaic power generator or a wind power generator may be used in place of storage battery R2. In this case, the estimated value of the maximum amount of power that can be generated should be used in place of the chargeable/dischargeable capacity.

### Fourth Exemplary Embodiment

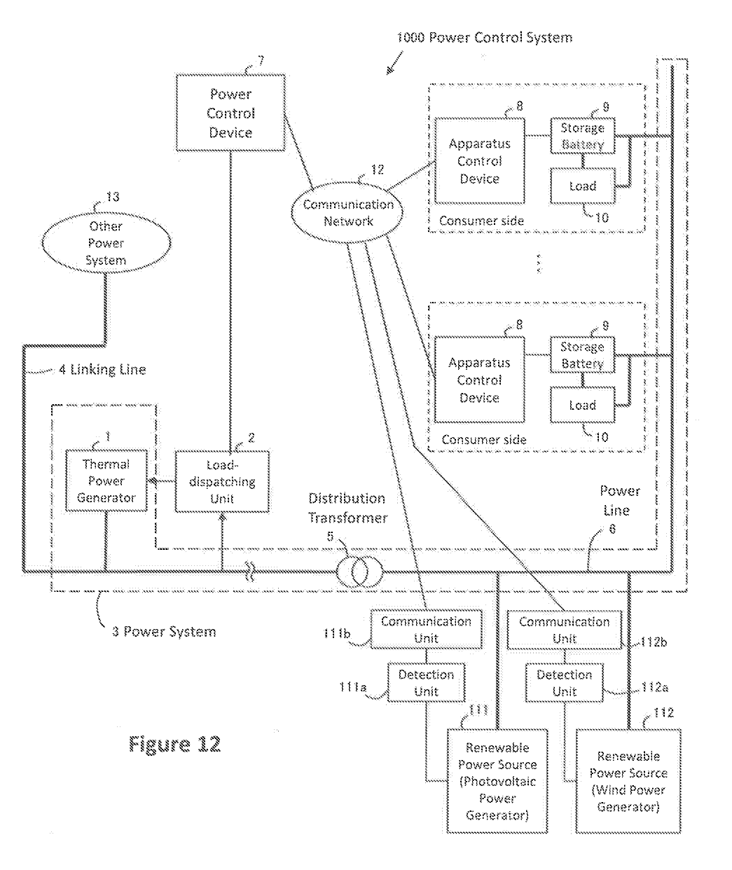

FIG. 12 shows power control system 1000 that adopts the fourth exemplary embodiment of the present invention.

Power control system 1000 includes thermal power generator 1, load-dispatching unit 2, power system 3, linking line 4, distribution transformer 5, power line 6, power control device 7, a plurality of apparatus control devices 8, a plurality of storage batteries 9, and a plurality of loads 10. Power control device 7 is an example of a control device.

Thermal power generator 1, load-dispatching unit 2, power system 3, linking line 4, distribution transformer 5, and power line 6 are devices owned by a power company.

Power control device 7 is a device that is owned by a PPS (Power Producer and Supplier). Power control device 7 may also be owned by an aggregator.

Apparatus control devices 8, storage batteries 9, and loads 10 are devices owned by each consumes. Each consumer may be a typical household or structure such as a building.

Thermal power generator 1, distribution transformer 5, and power line 6 are included in power system 3. Renewable power source (photovoltaic power generator) 111 and renewable power source (wind power generator) 112 are connected to power system 3.

In FIG. 12, one renewable power source 111 and one renewable power source 112 are shown, but in actuality, a plurality of renewable power sources 111 and a plurality of renewable power sources 112 are connected to power system 3.

Detection unit 111a detects the power generation amount of renewable power source 111. Communication unit 111b reports the detection result of detection unit 111a to power control device 7. Detection unit 111a and communication unit 111b are provided for each renewable power source 111.

Detection unit 112a detects the power generation amount of renewable power source 112. Communication unit 112b reports the detection result of detection unit 112a to power control device 7. Detection unit 112a and communication unit 112b are provided for each renewable power source 112.

Storage batteries 9 are an example of power supply/demand adjustment devices. Storage batteries 9 are connected to power system 3. Loads 10 are, for example, household appliances.

An outline of the functions of power control system 1000 is first described.

Load-dispatching unit 2 on the power company side transmits demands for power supply/demand adjustment processing to power control device 7 on the PPS side.

Power control device 7 on the PPS side receives the demands of the power company from load-dispatching unit 2.

Power control device 7 generates for each apparatus control device 8 operation control information for controlling storage batteries 9. At this time, power control device 7 generates operation control information that reflects the status information of storage batteries 9 (for example, the residual capacity or SOC) and the content of power supply/demand adjustment processes (such as LFC) that accord with the demands.

In the present exemplary embodiment power control device 7 generates operation control information that accords with each of all apparatus control devices 8 at the operation start time.

Power control device 7 then, after the operation start time, generates operation control information for a portion of apparatus control devices 8 when status information could not be received from all storage batteries 9 during period T1. Power control device 7 regards apparatus control devices for which the status information of corresponding storage batteries 9 was received (hereinbelow referred to as “processing-object apparatus control devices”) as apparatus control devices 8 for which operation control information is to be generated.

At this time, power control device 7 adopts, as the status information of storage batteries 9 that could not be received within period T1, status information that was received in the past for storage batteries 9.

When the demand is a “first LFC demand,” power control device 7 generates first LFC operation control information for executing a first LFC adjustment process (hereinbelow referred to as “DR application 1”) that uses the integrated value of the frequency deviation of power system 3 to control the operation of storage batteries 9.

When the demand is a “second LFC demand,” power control device 7 generates second LFC operation control information to execute a second LFC adjustment process (hereinbelow referred to as “DR application 2”) that uses an index to control the operation of storage batteries 9. The index in this case is similar to the index described in the modification of the third exemplary embodiment.

In the following explanation, each storage battery 9 is assumed to be assigned to DR applications 1-2.

Power control device 7 transmits demands that have been received to apparatus control devices 8.

Power control device 7 provides time intervals to repeatedly transmit operation control information to apparatus control devices 8.

For example, power control device 7 transmits operation control information to processing-object apparatus control devices 8.

Power control device 7 provides time intervals to repeatedly transmit indices to apparatus control devices 8.

The transmission spacing of operation control information is longer than the transmission spacing of indices.

Upon receiving a demand, apparatus control device 8, in accordance with the demand, determines usage information (either the frequency of power system 3 or an index and operation control information that accords with the demand) that is used in the power supply/demand adjustment process that corresponds to the demand.

Apparatus control devices 8 execute power supply/demand adjustment processes (DR applications 1-2) that accord with demands by using the usage information to control the operation of storage batteries 9. The power supply/demand adjustment processes that accord with demands refer to responses to the demands (hereinbelow also referred to as “responses”).

The configuration of power control system 1000 is next described.

Thermal power generator 1 is an example of a power generator. Load-dispatching unit 2 communicates with power control device 7. Load-dispatching unit 2 transmits demands (first LFC demand and second LFC demand) to power control device 7. Power system 3 is a system that supplies electric power to the consumer side. Power system 3 transforms the voltage of the generated power that is supplied from thermal power generator 1 to a predetermined voltage at distribution transformer 5. Power system 3 supplies electric power of a predetermined voltage to the consumer side.

Linking line 4 connects power system 3 and another power system 13.

Power control device 7 receives demands (first LFC demands and second LFC demands) of a power company from load-dispatching unit 2.

Power control device 7 creates operation control information for each of DR applications 1-2.

Power control device 7 transmits the demands that were received to apparatus control devices 8. Power control device 7 provides time intervals for repeatedly transmitting operation control information to apparatus control devices 8. Power control device 7 provides time intervals for repeatedly transmitting indices to apparatus control devices 8.

Apparatus control devices 8 determine usage information that is to be used in the power supply/demand adjustment processes that correspond to demands in accordance with the demands that are received from power control device 7. Apparatus control devices 8 use the usage information to control the operation of storage batteries 9.

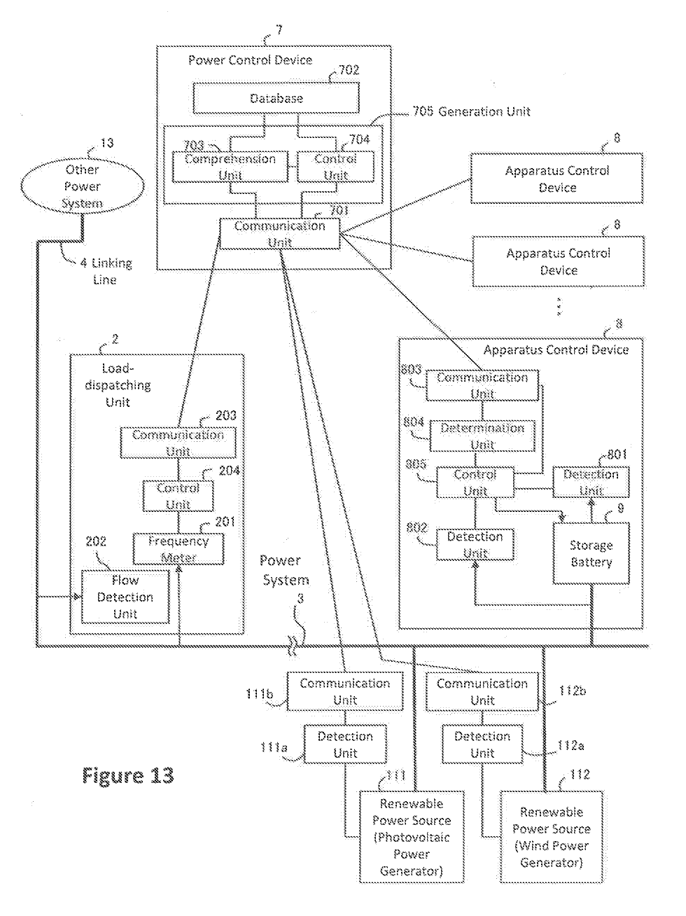

FIG. 13 shows an example of load-dispatching unit 2, power control device 7, and a plurality of apparatus control devices 8. In FIG. 13, constituent elements that are identical to elements shown in FIG. 12 are given the same reference numbers. In FIG. 13, communication network 12 is omitted. In FIG. 13, storage batteries 9 are incorporated in apparatus control devices 8, but storage batteries 9 need not be incorporated in apparatus control devices 8. Apparatus control devices 8 that incorporate storage batteries 9 are examples of storage devices.

Apparatus control devices 8 are first described.

Each apparatus control device 8 controls the operation of storage battery 9. Apparatus control device 8 includes detection units 801 and 802, communication unit 803, determination unit 804, and control unit 805.

Detection unit 801 detects the SOC of storage battery 9. The SOC of storage battery 9 is a value within the range of 0-1. The SOC of storage battery 9 represents the status information of storage battery 9. The status information of storage battery 9 is not limited to the SOC of storage battery 9 and can be altered as appropriate. For example, the cell temperature, amount of current or voltage of storage battery 9 may also be used as the status information of storage battery 9.

Detection unit 802 detects the frequency of power system 3. Detection unit 802 may be inside or outside apparatus control device 8. When detection unit 802 is outside apparatus control device 8, control unit 805 detects (receives) the frequency of power system 3 by receiving the detection result of detection unit 802.

Communication unit 803 is an example of an acceptance unit, a reception unit, or a transmission/reception unit. Communication unit 803 communicates with power control device 7.

Communication unit 803 receives demands, operation control information, and indices from power control device 7.

For example, communication unit 803 receives demands transmitted from power control device 7 using bidirectional communication, for example, MQTT (Message Queuing Telemetry Transport). Communication unit 803 may also receive demands transmitted from power control device 7 by one-way communication such as by broadcast.

Communication unit 803 receives indices transmitted by one-way communication such as by broadcast from power control device 7. Communication unit 803 may further receive indices transmitted from power control device 7 using bidirectional communication such as MQTT.

Communication unit 803 receives operation control information transmitted from power control device 7 using bidirectional communication such as MQTT.

Determination unit 804 determines the usage information in accordance with the demands that were received by communication unit 803.

Control unit 805 uses the usage information that was determined by determination unit 804 to control the charging/discharging operation of storage battery 9.

Control unit 805 executes an information acquisition operation (transmission/reception process) of obtaining operation control information from power control device 7 and a control operation (battery operation control process) of using operation control information to control the charging/discharging operation of storage battery 9.

Control unit 805 provides time intervals for repeatedly executing the information acquisition process.

Control unit 805 provides time intervals that are shorter than the time intervals of the information acquisition process to repeatedly execute the control operation.

For example, control unit 805 repeatedly executes the information acquisition operation at period T and repeatedly executes the control operation at period T₁ (where T>T₁). Period T is an example of the predetermined time interval. Alternatively, control unit 805 repeatedly executes the detection of the frequency of power system 3 as well as the transmission and reception of indices at period T₁.

The operation time interval of the information acquisition operation, the operation time interval of the control operation, or both need not be fixed, but the shortest time of each operation time interval of the information acquisition operation should be longer than the longest time of each operation time interval of the control operation.

Apparatus control devices 8, storage batteries 9, and loads 10 are devices owned by each consumer. Further, apparatus control devices 8 and storage batteries 9 may be owned by a PPS or aggregator that is provided with power control device 7 and may be arranged to enable the use of each as load 10 of each consumer. In this case, the PPS or aggregator that is the essential owner of apparatus control devices 8 and storage batteries 9 can freely control apparatus control devices 8 and storage batteries 9, but by forming a predetermined contract, consumers are also able to use apparatus control devices 8 and storage batteries 9 for controlling loads 10.

Power control device 7 is next described.

Power control device 7 places N apparatus control devices 8 and N storage batteries 9 under its control. For example, N apparatus control devices 8 and N storage batteries 9 are devices that are maintained by consumers who are supplied with electric power from a PPS. Here, N is an integer equal to or greater than 2. Power control device 7 includes communication unit 701, database 702, comprehension unit 703, and control unit 704. Comprehension unit 703 and control unit 704 are included in generation unit 705.

Communication unit 701 communicates with each apparatus control device 8, load-dispatching unit 2, communication unit 111b, and communication unit 112b. For example, communication unit 701 receives the SOC and ID (identification) of storage batteries 9 from each apparatus control device 8. Communication unit 701 further receives information indicating the power generation amount of renewable power sources 111 and 112 from communication units 111b and 112b.

Database 702 stores the information of each storage battery 9.

In addition, database 702 holds the storage battery distribution ratio curves that are used for finding the chargeable/dischargeable capacity of storage batteries 9 based on the SOC of storage batteries 9 that is received by communication unit 701. Further, database 702 also holds the rated output P(n) of each storage battery 9 that is used for finding the chargeable/dischargeable capacity. The rated output of a power conditioner (AC/DC converter) (not shown in the figures) that is connected to storage battery 9 is used as the rated output P(n) of storage battery 9.

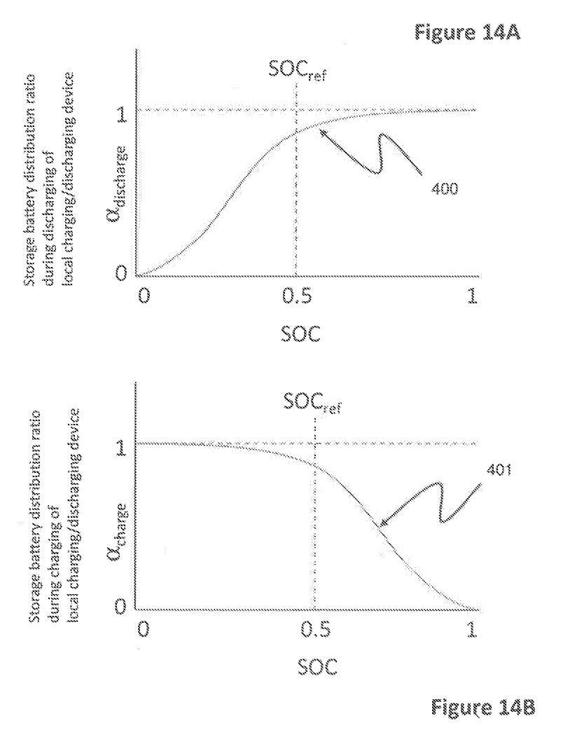

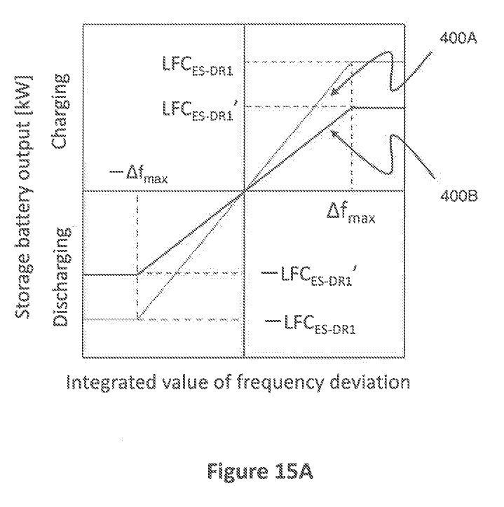

FIGS. 14A and 14B show examples of the storage battery distribution ratio curves. FIG 14A shows an example of storage battery distribution ratio curve 202a during discharge. FIG 14B shows an example of storage battery distribution ratio curve 202b during discharging.

Comprehension unit 703 comprehends the power amount that is allotted (hereinbelow referred to as “DR1 allotted power amount”−“DR2 allotted power amount”) that is borne by N storage batteries 9 that are under the control of power control device 7 to adjust the power amount in power system 3. Each allotted power amount is an example of the state of the power system.

Comprehension unit 703 comprehends the DR1 allotted power amount as shown below.

Comprehension unit 703 uses the storage battery distribution ratio curve in database 702 to derive the chargeable/dischargeable capacity of a storage battery group that is made up of N storage batteries 9 (hereinbelow referred to as simply a “storage battery group”) based on the SOC of the N storage batteries 9. The chargeable/dischargeable capacity of the storage battery group is hereinbelow referred to as “total adjustable capacity P_{ES}”.

When the SOC of only a portion of N storage batteries 9 is received, comprehension unit 703 determines the SOC of storage batteries 9 that could not be received as shown below. Comprehension unit 703 uses, as the SOC of storage batteries 9 that could not be received, the most recent SOC value among SOC that was received in the past for these storage batteries 9.

Comprehension unit 703 may also acquire from control unit 704 the “previous allotted power amount information” of storage batteries 9 for which SOC could not be received and then estimate the SOC of storage batteries 9 for which SOC could not be received based on the time elapsed from the time of previous distribution of the “previous allotted power amount information”. The allotted power amount information will be described hereinbelow.

When the SOC of a portion of N storage batteries 9 could not be received, comprehension unit 703 may also use the storage battery group that is made up by a portion of storage batteries 9 (hereinbelow referred to as a “partial storage battery group”) in place of the storage battery group that is made up by N storage batteries 9. In this case, comprehension unit 703 determines the chargeable/dischargeable capacity of the partial storage battery group for which the SOC could be received based on the SOC of this portion of storage batteries 9. The explanation for a case in which the SOC of only a portion of N storage batteries 9 could be received is hereinbelow presented by substituting the number N of storage batteries 9 by the number “N−a” of this portion of storage batteries 9.

Comprehension unit 703 transmits total adjustable capacity P_{ES} from communication unit 701 to load-dispatching unit 2. Comprehension unit 703 then receives, from load-dispatching unit 2 by way of communication unit 701, DR1 allotted power amount information that shows the DR allotted power amount that reflects total adjustable capacity P_{ES}. Comprehension unit 703 uses the DR1 allotted power amount information to comprehend the DR1 allotted power amount.

In the present exemplary embodiment, a DR1 charge/discharge gain line is used as the DR1 allotted power amount information. The DR1 charge/discharge gain line shows the LFC assignment capacity LFC_{ES-DR}1 that shows the DR1 maximum allotted power amount and the maximum value (threshold value) Δfₘₐₓ of the integrated value of frequency deviation (although there are ±Δfₘₐₓ, ± is omitted hereinbelow in the interest of simplification).

The “maximum value of the integrated value of frequency deviation” is used as the threshold value of the integrated value of the amount of divergence of the system frequency with respect to the reference frequency.

Further, the “maximum value of the integrated value of frequency deviation” means the “maximum amount of divergence of the integrated value of frequency deviation” that can be accommodated at total output LFC_{ES-DR}1 of N storage batteries 9 that execute DR application 1. When the integrated value of frequency deviation becomes a value equal to or greater than the maximum value (threshold value) of the integrated value of frequency deviation, accommodation by means of LFC_{ES-DR}1 becomes problematic.

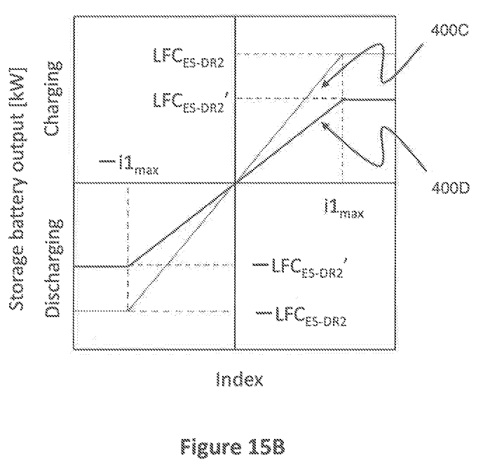

FIG. 15A shows an example of the DR1 charge/discharge gain line. Details regarding the DR1 charge/discharge gain line will be described hereinbelow.

The DR1 charge/discharge gain line shows the relation between the integrated value of frequency deviation and the output of a storage battery group (the total output of N storage batteries 9 that execute DR application 1).

Control unit 704 generates the DR1 allotment information of each storage battery 9 that executes DR application 1 such that the relation between the integrated value of frequency deviation and the output of the storage battery group shown by the DR1 charge/discharge gain line is satisfied. The DR1 allotment information is an example of the first LFC operation control information.

In the present exemplary embodiment, control unit 704 generates DR1 allotment information (DR1 allotment coefficient K1 and maximum value Δfₘₐₓ of the integrated value of frequency deviation) of each storage battery 9 that executes DR application 1 on the basis of the SOC of storage batteries 9 that execute DR application 1 and the DR1 charge/discharge gain line. Control unit 704 transmits the DR1 allotment information from communication unit 701 to each apparatus control device 8 that executes DR application 1. The DR1 allotment coefficient K1 is a large value that increases in proportion to the level of the allotment ratio of storage batteries 9 that execute DR application 1.

Comprehension unit 703 comprehends the DR2 allotted power amount as shown below.

Comprehension unit 703 uses the storage battery distribution ratio curve in database 702 to derive the chargeable/dischargeable capacity (total adjustable capacity P_{ES}) of the storage battery group. The storage battery distribution ratio curve used here need not necessarily be the same as the storage battery distribution ratio curve used when deriving the DR1 allotted power amount.

When SOC could be received from only a portion of the N storage batteries 9, comprehension unit 703 determines the SOC of storage batteries 9 for which SOC could not be received as shown below. Comprehension unit 703 uses, as the SOC of storage batteries 9 that could not be received, the values of the most recent SOC of the SOC received in the past for these storage batteries 9.

Further, comprehension unit 703 may acquire “previous allotted power amount information” of storage batteries 9 for which SOC could not be received from control unit 704 and estimate the SOC of storage batteries 9 for which SOC could not be received based on the “previous allotted power amount information” and the elapsed time from the previous distribution time.

When the SOC could be received from only a portion of N storage batteries 9, comprehension unit 703 may also use the storage battery group that is made up of a portion of storage batteries 9 (hereinbelow referred to as a “partial storage battery group”) in place of the storage battery group that is made up by N storage batteries 9. In this case, comprehension unit 703 determines the chargeable/dischargeable capacity of the partial storage battery group for which the SOC could be received based on the SOC of this portion of storage batteries 9. The explanation for a case in which the SOC of only a portion of N storage batteries 9 could be received is presented by substituting the number “N” of storage batteries 9 with the number “N−b” of this portion of storage batteries 9.

Comprehension unit 703 transmits total adjustable capacity P_{ES} from communication unit 701 to load-dispatching unit 2. Comprehension unit 703 then receives DR2 allotted power amount information that shows the DR2 allotted power amount that reflects the total adjustable capacity P_{ES} from load-dispatching unit 2 by way of communication unit 701. Comprehension unit 703 uses the DR2 allotted power amount information to comprehend the DR2 allotted power amount.

In the present exemplary embodiment, a DR2 charge/discharge gain line is used as the DR2 allotted power amount information. The DR2 charge/discharge gain line shows the LFC assignment capacity LFC_{ES-DR}2 that shows the DR2 maximum allotted power amount and the maximum value (threshold value) i1ₘₐₓ (although there are ±i1ₘₐₓ, the ± is hereinbelow omitted in the interest of simplification) of the index.

“Maximum value of the index” is used as the threshold value of the index.

Further, “maximum value of the index” refers to the “maximum amount of divergence of the index” that can be accommodated by the total output LFC_{ES-DR}2 of N storage batteries 9 that execute DR application 2. When the index becomes a value equal to or greater than the maximum value (threshold value) of the index, accommodation by means of LFC_{ES-DR}2 becomes problematic.

FIG. 15B shows an example of the DR2 charge/discharge gain line. Details of the DR2 charge/discharge gain line will be described later.

The DR2 charge/discharge gain line shows the relation between the index and the output of the storage battery group (the total output of N storage batteries 9 that execute DR application 2).

Control unit 704 generates DR2 allotment information of each storage battery 9 that executes DR application 2 such that the relation between the index and the output of the storage battery group indicated by the DR2 charge/discharge gain line is satisfied. The DR2 allotment information is an example of the second LFC operation control information.

In the present exemplary embodiment, control unit 704 generates DR2 allotment information (DR2 allotment coefficient K2 and the maximum value i1ₘₐₓ of the index) of each storage battery 9 that executes DR application 2 on the basis of the SOC of storage batteries 9 that execute DR application 2 and the DR2 charge/discharge gain line. Control unit 704 transmits the DR2 allotment information from communication unit 701 to each apparatus control device 8 that executes DR application 2. DR2 allotment coefficient K2 is a value that increases in proportion to higher levels of the allotment ratio of storage batteries 9 that execute DR application 2.

Load-dispatching unit 2 is next described.

Load-dispatching unit 2 includes frequency meter 201, flow detection unit 202, communication unit 203, and control unit 204.

Frequency meter 201 detects the frequency of power system 3.

Flow detection unit 202 detects the power flow in linking line 4.

Communication unit 203 communicates with power control device 7.

For example, communication unit 203 receives total adjustable capacity P_{ES} from power control device 7. Communication unit 203 further transmits the DR1 charge/discharge gain line and the DR2 charge/discharge gain line to power control device 7.

Control unit 204 controls the operation of load-dispatching unit 2.

For example, Control unit 204 transmits various demands to power control device 7 by way of communication unit 203.

In addition, control unit 204 uses the detection result of frequency meter 201 and the detection result of flow detection unit 202 to generate an index. The method of generating the index is similar to the method described in the modification of the third exemplary embodiment. Control unit 204 transmits the index from communication unit 203 to power control device 7. In power control device 7, control unit 704, having received the index by way of communication unit 701, transmits the index from communication unit 701 to each apparatus control device 8.

In addition, control unit 204 further generates the DR1 charge/discharge gain line and DR2 charge/discharge gain line as shown below.

The method of generating the DR1 charge/discharge gain line (DR1 allotted power amount information) is first described.

Control unit 204 uses the system frequency that was detected at frequency meter 201 to calculate the Area Requirement (AR) that is the corrected output amount of a power plant. Control unit 204 uses the area requirement AR, the LFC adjustment capacity of thermal power generator 1 that is the object of control, and total adjustable capacity P_{ES} to derive the LFC capacity. Control unit 204 acquires the LFC adjustment capacity of thermal power generator 1 from a thermal power generator control unit (not shown). The total adjustable capacity P_{ES} is supplied to control unit 204 from communication unit 203.

Control unit 204 assigns to thermal power generator 1, of the LFC capacity, the capacity from which the rapid change component has been eliminated. Control unit 203 assigns the remaining LFC capacity LFC_{ES-DR}1 (where LFC_{ES-DR}1≦P_{ES}) to the storage battery group. For example, control unit 204 uses a high-pass filter that passes, of the LFC capacity, a fluctuation component having a period of 10 seconds or less but that does not pass a fluctuation component having a period longer than 10 seconds, to extract the rapid fluctuation component (capacity LFC_{ES-DR}1) from the LFC capacity.

Otherwise, control unit 204 allots the LFC capacity in accordance with a ratio that has been set in advance (predetermined value) to each thermal power generator 1 and storage battery group.

Control unit 204 treats capacity LFC_{ES-DR}1 as LFC assignment capacity LFC_{ES-DR}1.

Control unit 204 generates DR1 charge/discharge gain line (see FIG. 15A) that shows LFC assignment capacity LFC_{ES-DR}1 and maximum value (threshold value) Δfₘₐₓ of the integrated value of the frequency deviation that has been set in advance.

Control unit 204 transmits the DR1 charge/discharge gain line from communication unit 202 to power control device 7.

The method of generating DR2 charge/discharge gain line (DR2 allotted power amount information) is next described.

The method of generating DR2 charge/discharge gain line (DR2 allotted power amount information) is similar to the method of generating the DR1 charge/discharge gain line (DR1 allotted power amount).

The operation is next described.

[1] The operation in which apparatus control device 8 determines usage information:

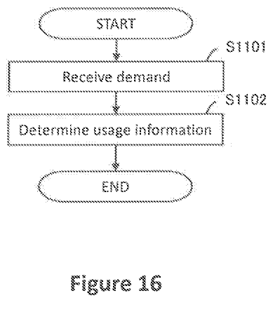

FIG. 16 is a flow chart for describing the operation by which apparatus control device 8 determines the usage information.

Control unit 704 in power control device 7, upon receiving a demand (a demand of the power company) from load-dispatching unit 2, transmits this demand from communication unit 701 to apparatus control device 8.

In apparatus control device 8, communication unit 803, having received the demand (Step S1101), supplies the demand to determination unit 804.

Time slot information that indicates the execution time slot of the DR application requested by the demand is appended to each demand.

Determination unit 804, upon receiving the demand, determines the usage information that is to be used in the DR application that is specified by the demand according to the demand (Step S1102).

When the demand is a “first LFC demand” in Step S1102, determination unit 804 determines the first LFC operation control information and the frequency of power system 3 as the usage information. When the demand is a “second LFC demand,” determination unit 804 determines the second LFC operation control information and an index as the usage information.

Determination unit 804 supplies the determination result of usage information and the demand (demand with appended time slot information) to control unit 805.

Control unit 805, having received the determination result of usage information and the demand, holds the determination result of usage information and the demand.

[2] Operation of executing DR application 1 (first LFC adjustment process)

A summary of the DR application 1 execution operation is first described.

(2-1) Power control device 7 receives and collects from apparatus control devices 8 the SOC of storage batteries 9 at period T1_{FirstLFC}. Period T1_{FirstLFC} is, for example, 15 minutes.

(2-2) Power control device 7 derives total adjustable capacity P_{ES} on the basis of the SOC of storage batteries 9 for each collection of SOC of storage batteries 9.

After the operation start time, if the SOC of all storage batteries 9 could not be received within period T1_{FirstLFC}, power control device 7 derives total adjustable capacity P_{ES} by adopting, as the SOC of storage batteries 9 that could not be received, the most recent SOC among the SOC that was received in the past for these storage batteries 9.

(2-3) Power control device 7 next transmits the total adjustable capacity P_{ES} to load-dispatching unit 2 at period Tₘ. Period Tₘ is equal to or greater than period T1_{FirstLFC}, and is, for example, 15 minutes.

(2-4) Load-dispatching unit 2 calculates first LFC assignment capacity LFC_{ES-DR}1 (where LFC_{ES-DR}1≦P_{ES}) for the storage battery group for each reception of total adjustable capacity P_{ES}.

(2-5) Load-dispatching unit 2 uses the LFC assignment capacity LFC_{ES-DR}1 and the maximum value Δfₘₐₓ of the integrated value of frequency deviation to create, for each calculation of the first LFC assignment capacity LFC_{ES-DR}1, a DR1 charge/discharge gain line. Load-dispatching unit 2 then transmits the DR1 charge/discharge gain line to power control device 7.

(2-6) Power control device 7 calculates DR1 allotment coefficient K1 in accordance with the most recent DR1 charge/discharge gain line that was received from load-dispatching unit 2.

(2-7) Power control device 7 next transmits DR1 allotment information (DR1 allotment coefficient K1 and the maximum value Δfₘₐₓ of the integrated value of frequency deviation) to apparatus control devices 8 (for example, processing-object apparatus control devices 8) at period T1_{FirstLFC}.

(2-8) Each apparatus control device 8 calculates a first local charge/discharge gain line that stipulates the charging/discharging operation of storage batteries 9 on the basis of DR1 allotment coefficient K1 and the maximum value Δfₘₐₓ of the integrated value of frequency deviation. The first local charge/discharge gain line will be described hereinbelow.

(2-9) Each apparatus control device 8 uses the first local charge/discharge gain line and the frequency of power system 3 to control the charging/discharging operation of storage battery 9.

Details of the operation of executing DR application 1 (first LFC adjustment process) are next described.

The operation in which power control device 7 derives total adjustable capacity P_{ES} on the basis of the SOC of storage batteries 9 that execute DR application 1 (hereinbelow referred to as the “P_{ES} derivation operation”) is first described.

The derivation of total adjustable capacity P_{ES} requires information such as the rated output P(n) of storage batteries 9 (the output value of power conditioners, storage battery capacity, usable SOC range (for example, a range of from 30% to 90%)). Because these items of information are basically static information, power control device 7 in the present exemplary embodiment is assumed to have acquired these items of information from each apparatus control device 8 in advance.

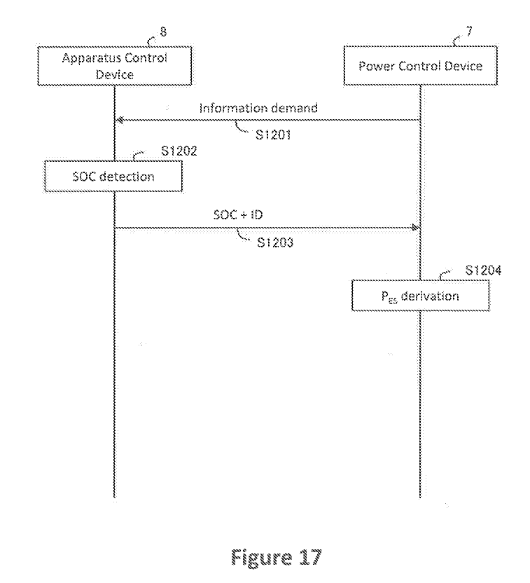

FIG. 17 is a sequence diagram for describing the P_{ES} derivation operation. In FIG. 17, the number of apparatus control devices 8 is assumed to be “one” in the interest of simplifying the explanation.

Communication unit 701 of power control device 7 transmits to each apparatus control device 8 an information demand indicating a demand for SOC (Step S1201).

In each apparatus control device 8, upon receiving the information demand indicating a demand for the SOC by way of communication unit 803, control unit 805 causes detection unit 801 to detect the SOC of storage battery 9 (Step S1202).

Control unit 805 next transmits the SOC that was detected by detection unit 801 together with the ID from communication unit 803 to power control device 7 (Step S1203). It will be assumed in the following explanation that the ID is a sequential number (n) from “1” to “N”.

Power control device 7, having received the SOC to which the ID has been appended (hereinbelow referred to as “SOC(n)”) from apparatus control device 8, derives total adjustable capacity P_{ES} (Step S1204).

Power control device 7 and each apparatus control device 8 repeat the operations of Steps S1201-S1204 (the P_{ES} derivation operation) at period T1_{FirstLFC}. Period T1_{FirstLFC} may be varied within a range that satisfies the requirements of the demand depending on other circumstances such as the state of the communication network or breakdown circumstances of storage batteries.

Step S1204 (the derivation of total adjustable capacity P_{ES}) is next described.

Communication unit 701 of power control device 7 collects SOC(n) from each apparatus control device 8 at period T1_{FirstLFC}.

Here, when communication unit 701 was unable to receive SOC(n) from at least one apparatus control device 8 among all apparatus control devices 8 during period T1_{FirstLFC}, comprehension unit 703 uses the most recent SOC of the SOC of storage battery 9 that was received in the past as the SOC of storage battery 9 that could not be received. When there is no SOC that was received in the past, comprehension unit 703 may also use a predetermined value (such as a default SOC) as the SOC of storage battery 9 that could not be received.

Comprehension unit 703 next uses SOC(n) and storage battery distribution ratio curves 202a and 202b in database 702 to derive storage battery distribution ratio α_{discharge}(n) during discharging and storage battery distribution ratio α_{charge}(n) during charging for each storage battery 9.

In the present exemplary embodiment, the curves shown in FIGS. 14A and 14B that have been altered according to information related to the execution time that is required by DR application 1 and information of the rated output P(n) of storage batteries 9 (the output values of power conditioners and the storage battery capacity) are used as storage battery distribution ratio curves 202a and 202b.

For example, a curve is used such that the value of total adjustable capacity P_{ES} that is derived by the process described hereinbelow is a value that allows a storage battery group to at least continue charging/discharging during the interval of period T1_{FirstLFC} (in the case of the current instance, equal to the execution time required by DR application 1). In addition, the storage battery distribution ratio curves are not limited to the curves here described and can be altered as appropriate according to the demand and the DR application.

Comprehension unit 703 next uses storage battery distribution ratio α_{discharge}(n) during discharging, storage battery distribution ratio α_{charge}(n) during charging, the rated output P(n) of each of a total N storage batteries 9 in database 702, and the formulas shown in Numerical Expression 1 and Numerical Expression 2 to derive P_{ES,discharging} and P_{ES,charging}.

$$\begin{matrix}{P}_{ES , discharging} = {\sum }_{n = 1}^{N} {α}_{discharging} ( n ) \cdot P ( n ) & Numerical Expression 1 \\ {P}_{ES , charging} = {\sum }_{n = 1}^{N} {α}_{charging} ( n ) \cdot P ( n ) & Numerical Expression 2\end{matrix}$$

Comprehension unit 703 next adopts, of P_{ES,discharging} and P_{ES,charging}, the smaller value as the total adjustable capacity P_{ES-DR}2.

The operation by which power control device 7 communicates with load-dispatching unit 2 to comprehend the DR1 charge/discharge gain line (hereinbelow referred to as the “DR1 comprehension operation”) is next described.

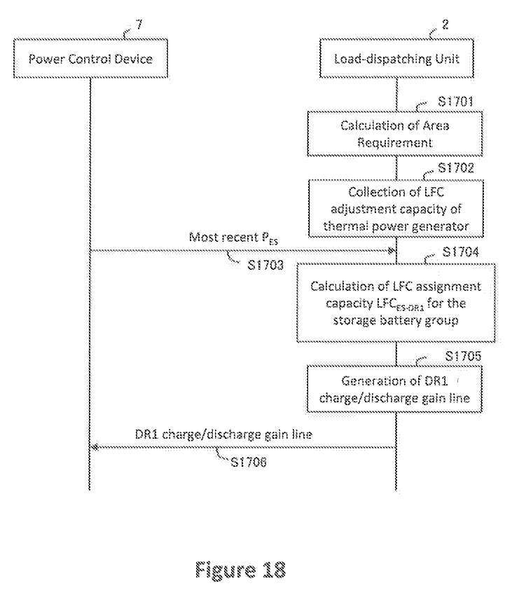

FIG. 18 is a sequence diagram for describing the DR1 comprehension operation.

Control unit 204 of load-dispatching unit 2 uses the system frequency that was detected by frequency meter 201 to calculate the area requirement (AR) (Step S1701).

Control unit 204 next collects the LFC adjustment capacity of thermal power generator 1 from the thermal power generator control unit (not shown) (Step S1702).

On the other hand, communication unit 701 of power control device 7 transmits the most recent total adjustable capacity P_{ES} to load-dispatching unit 2 (Step S1703).

Communication unit 203 of load-dispatching unit 2 receives the most recent total adjustable capacity P_{ES} that was transmitted from communication unit 701 of power control device 7. Communication unit 203 supplies this most recent total adjustable capacity P_{ES} to control unit 204.

Control unit 204, upon receiving the most recent total adjustable capacity P_{ES}, uses the area requirement AR, the LFC adjustment capacity of thermal power generator 1, and the most recent total adjustable capacity P_{ES} to derive the LFC capacity. Control unit 204 next assigns to thermal power generator 1, of the LFC capacity, the capacity from which the rapid fluctuation component has been removed. Control unit 204 then assigns the remaining LFC capacity LFC_{ES-DR}1 (where LFC_{ES-DR}1≦P_{ES}) to the storage battery group that is to execute DR application 1 as the LFC assignment capacity LFC_{ES-DR}1 (Step S1704).

Control unit 204 determines the ratio of the assignment of the LFC capacity to thermal power generator 1 and the LFC assignment capacity LFC_{ES-DR}1 while giving consideration to the viewpoint of economy while also taking into consideration the assigned portion of the EDC (Economic Load Dispatching Control) component.

Control unit 204 next generates DR1 charge/discharge gain line (see FIG. 15A) that represents the LFC assignment capacity LFC_{ES-DR}1 and the maximum value Δfₘₐₓ of the integrated value of the frequency deviation that was set beforehand (Step S1705).

The DR1 charge/discharge gain line shown in FIG. 15A represents the charging/discharging amount of the storage battery group (storage batteries 9 that are to execute DR application 1) with respect to the integrated value Δf of the frequency deviation. The DR1 charge/discharge gain line changes by becoming line 400A and then line 400B according to the size of the LFC assignment capacity LFC_{ES-DR}1 (LFC_{ES-DR}1 and LFC_{ES-DR}1′) within the range in which “LFC assignment capacity LFC_{ES-DR}1≦total adjustable capacity P_{ES}”.

Control unit 204 then transmits the DR1 charge/discharge gain line from communication unit 203 to power control device 7 (Step S1706).

Power control device 7 and load-dispatching unit 2 repeat the operations of Steps S1701-S1706 (DR1 comprehension operation) at period Tₘ.

Comprehension unit 703 of power control device 7 receives the DR1 charge/discharge gain line by way of communication unit 701 and holds, of the DR1 charge/discharge gain lines, the most recent charge/discharge gain line.

The operations of generating DR1 allotment information, transmitting the DR1 allotment information to each apparatus control device 8, and deriving the local charge/discharge gain line for the operation by which each apparatus control device 8 controls the operation of storage batteries 9 on the basis of the DR1 allotment information (hereinbelow referred to as the “DR1 allotment operations”) are next described.

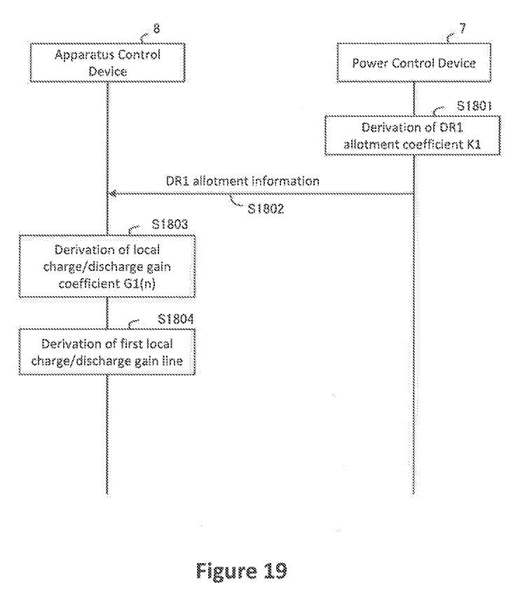

FIG. 19 is a sequence diagram for describing the DR1 allotment operations. In FIG. 19, the number of apparatus control devices 8 that execute DR application 1 is assumed to be “1” in the interest of simplifying the explanation.

Control unit 704 of power control device 7 uses the LFC assignment capacity LFC_{ES-DR}1 indicated in the most recent charge/discharge gain line, the most recent total adjustable capacity P_{ES}, and the equation shown in Numerical Expression 3 to derive DR1 allotment coefficient K1 (Step S1801).

$$K 1 = \frac{{LFC}_{ES \cdot DR 1}}{{P}_{ES}} \qquad Numerical Expression 3$$

Control unit 704 next transmits the DR1 allotment information that indicates DR1 allotment coefficient K1 and the maximum value Δfₘₐₓ of the integrated value of the frequency deviation indicated in the most recent DR1 charge/discharge gain line from communication unit 701 to apparatus control devices 8 that are to execute DR application 1 (Step S1802). DR1 allotment coefficient K1 is not limited to the value specified in Numerical Expression 3. For example, a value that indicates forcibly setting output close to the limit (for example, 0.97) when electric power supply/demand is under pressure, may also be used as DR1 allotment coefficient K1. The value that indicates forcibly setting output close to the limit is not limited to 0.97 and can be altered as appropriate.

Here, control unit 704 does not execute the process of Step S1802 for apparatus control devices 8 that correspond to storage batteries 9 for which SOC was not received.

In the present exemplary embodiment, the following process is executed in Step S1802.

Control unit 704 specifies, as the storage battery distribution ratio α(n) for each storage battery 9 that is to execute DR application 1 (storage batteries 9 for which SOC was received), the smaller value of the most recent storage battery distribution ratio α_{discharging}(n) during discharge and storage battery distribution ratio α_{charging}(n) during charge that were derived by comprehension unit 703.

Control unit 704 next generates, for each storage battery 9 that is to execute DR application 1 (storage batteries 9 for which SOC was received), operation-relevant information that represents the storage battery distribution ratio α(n) and the rated output P(n) that is being held in database 702.

Control unit 704 next appends the DR1 allotment information to each item of operation-relevant information.

Control unit 704 then transmits DR1 allotment information to which the operation-relevant information has been appended from communication unit 701 to each apparatus control device 8 that corresponds to the operation-relevant information. The DR1 allotment information to which the operation-relevant information has been appended is also an example of the first LFC operation control information.

In each apparatus control device 8 that is to execute DR application 1, control unit 805 receives the DR1 allotment information to which the operation-relevant information has been appended by way of communication unit 803.

Control unit 805 uses the DR1 allotment information to which the operation-relevant information has been appended and the equation shown in Numerical Expression 4 to derive local charging/discharging gain coefficient G1(n) (Step S1803).

$$G 1 ( n ) = \frac{K 1 \cdot α ( n ) \cdot P ( n )}{Δ {f}_{ma x}} \qquad Numerical Expression 4$$

The values in the equation of Numerical Expression 4 are indicated in the DR1 allotment information to which the operation-relevant information has been appended.

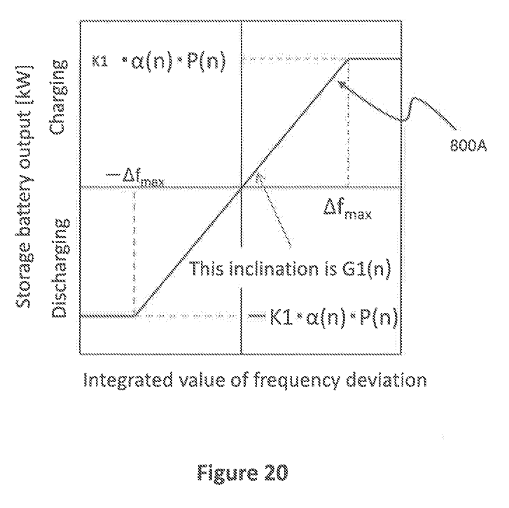

Control unit 805 then uses the local charging/discharging gain coefficient G1(n) and the maximum value Δfₘₐₓ of the integrated value of the frequency deviation indicated in the DR1 allotment information to which the operation-relevant information has been appended to derive first local charge/discharge gain line 800A shown in FIG. 20 (Step S1804).

First local charge/discharge gain line 800A that is shown in FIG. 20 is a straight line that, in the range in which the integrated value Δf of the frequency deviation is −Δfₘₐₓ≦Δf≦Δfₘₐₓ, passes through the origin 0 with an inclination that is the local charging/discharging gain coefficient G1(n). In addition, first local charge/discharge gain line 800A takes the fixed value “−K1·α(n)·P(n)” (where the minus sign indicates discharging) in the range in which the integrated value Δf of the frequency deviation is Δf<−Δfₘₐₓ. In addition, first local charge/discharge gain line 800A takes the fixed value “K1·α(n)·P(n)” in the range in which the integrated value Δf of the frequency deviation is Δfₘₐₓ<Δf.

Power control device 7 and each apparatus control device 8 that executes DR application 1 repeat Steps S1801-S1804 at period T1_{FirstLFC}.

In each apparatus control device 8 that executes DR application 1, control unit 805 receives the DR1 allotment information to which the operation-relevant information has been appended by way of communication unit 803 and holds, of the DR1 allotment information to which the operation-relevant information has been appended, the most recent DR1 allotment information to which operation-relevant information has been appended.

An operation in which apparatus control devices 8 that are to execute DR application 1 control the charging/discharging of storage batteries 9 on the basis of the DR1 allotment information to which the operation-relevant information has been appended and the system frequency (hereinbelow referred to as the “DR1 charging/discharging control operation”) is next described.

At the start time of DR application 1 that is indicated in the time slot information, control unit 704 of power control device 7 transmits DR1 execution interval information that indicates the operation period T2-A to apparatus control devices 8 that are to execute DR application 1 by way of communication unit 701. Operation period T2-A is, for example, 1 second. Upon receiving the DR1 execution interval information by way of communication unit 803, control unit 805 of each apparatus control device 8 that is to execute DR application 1 holds the DR2 execution interval information.

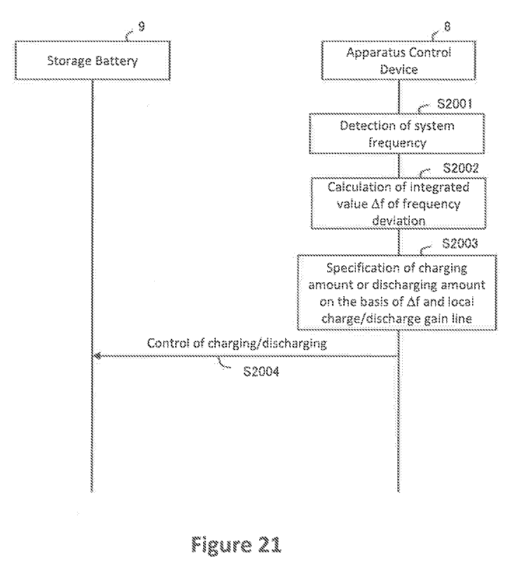

FIG. 21 is a sequence diagram for describing the charging/discharging control operation.

In each apparatus control device 8 that is to execute DR application 1, control unit 805 causes detection unit 802 to detect the system frequency (Step S2001).

Control unit 805 next calculates the integrated value Δf of the frequency deviation by subtracting the reference frequency of the system frequency from the detection result of detection unit 802 and then integrating this subtraction result (Step S2002).

Control unit 805 next calculates the charging amount or discharging amount of storage batteries 9 that are to execute DR application 1 in accordance with the integrated value Δf of the frequency deviation and the local charge/discharge gain line (Step S2003).

When the absolute value of the integrated value Δf of the frequency deviation is equal to or less than the maximum value (threshold value) Δfₘₐₓ of the integrated value of the frequency deviation in Step S2003, control unit 805 calculates as the adjustment power amount the absolute value of the value (G1(n)·Δf) that was obtained by multiplying the integrated value Δf of the frequency deviation by the local charging/discharging gain coefficient G1(n).

On the other hand, when the absolute value of the integrated value Δf of the frequency deviation is greater than the maximum value Δfₘₐₓ of the integrated value of frequency deviation, control unit 805 calculates as the adjustment power amount a value (K1·α(n)·P(n)) obtained by multiplying together the allotment coefficient K1, the storage battery distribution ratio α(n), and the rated output P(n).

In this example, FIG. 20 shows a case of point symmetry in which the inclination of G1(n) was the same on the charging side and discharging side, but in actuality, a case that is not point symmetry is also conceivable. In such a case as well, G1(n) is determined by the same approach as was described above.

Control unit 805 next causes storage batteries 9 that are to execute DR application 1 to execute a charging operation of the adjustment power amount when the integrated value Δf of the frequency deviation is a positive value. Alternatively, when the integrated value Δf of the frequency deviation is a negative value, control unit 805 causes storage batteries 9 that are to execute DR application 1 to execute a discharging operation of the adjustment power amount (Step S2004).

Each apparatus control device 8 repeats the processes of Steps S2001-S2004 at period T2-A that is indicated in the DR1 execution interval information. As a result, the value of the integrated value of the frequency deviation changes each time, and with each change, charging/discharging is effected according to G1(n)·Δf.

As a result, the integrated value of the frequency deviation changes each time at period T2-A (=1 second), and the charging/discharging operation of storage batteries 9 is carried out using the same DR1 allotment information until period T1_{FirstLFC} (=15 minutes) has elapsed.

Accordingly, in DR application 1 (the first LFC adjustment process), apparatus control devices 8 receive DR1 allotment information at period T1_{FirstLFC} (=15 minutes), detect the system frequency at period T2-A that is shorter than period T1_{FirstLFC}, and carry out charging/discharging operations of storage batteries 9 on the basis of the DR1 allotment information and system frequency at period T2-A. Because the DR1 allotment information that requires both bidirectional communication processing and time for acquisition is acquired at a period that is longer than the period of detecting the system frequency while the system frequency that fluctuates according to the balance between power supply and demand is detected at period T2-A as described hereinabove, the first LFC adjustment process can be accommodated.

[3] The operation of executing DR application 2 (second LFC adjustment process):

An outline of the DR application 2 execution operation is first described.

(3-1) Power control device 7 receives the SOC of storage batteries 9 from apparatus control devices 8 at period T1_{SecondLFC} and collects the SOC of storage batteries 9. Period T1_{SecondLFC} is, for example, 15 minutes.

(3-2) Power control device 7 derives total adjustable capacity P_{ES} on the basis of the SOC of storage batteries 9 for each collection of the SOC of storage batteries 9. Following the operation start time, when the SOC of all storage batteries 9 could not be received within period T1_{SecondLFC}, power control device 7 hereupon adopts as the SOC of storage batteries 9 that could not be received, the most recent SOC of the SOC that was received in the past for these storage batteries 9 to derive total adjustable capacity P_{ES}.

(3-3) Power control device next transmits the total adjustable capacity P_{ES} to load-dispatching unit 2 at period Tₘ. Period Tₘ is equal to or greater than period T1_{SecondLFC}.

(3-4) Load-dispatching unit 2 calculates the LFC assignment capacity LFC_{ES-DR}2 (where LFC_{ES-DR}2≦P_{ES}) for the storage battery group for each reception of total adjustable capacity P_{ES}.

(3-5) Load-dispatching unit 2 uses the maximum value i1ₘₐₓ of the index that is the integrated value of the corrected frequency deviation that was obtained by correcting frequency deviation by the flow in linking line 4 and the LFC assignment capacity LFC_{ES-DR}2 to create a DR2 charge/discharge gain line for each calculation of LFC assignment capacity LFC_{ES-DR}2. Load-dispatching unit 2 then transmits the DR2 charge/discharge gain line to power control device 7.

(3-6) Power control device 7 calculates DR2 allotment coefficient K2 in accordance with the most recent DR2 charge/discharge gain line that was received from load-dispatching unit 2.

(3-7) Power control device 7 next transmits the DR2 allotment information (the DR2 allotment coefficient K2 and maximum value i1ₘₐₓ of the index) to apparatus control devices 8 (for example, processing-object apparatus control devices 8) at period T1_{SecondLFC}.

(3-8) Each apparatus control device 8 calculates a second local charge/discharge gain line that stipulates the charging/discharging operation of storage battery 9 on the basis of the DR2 allotment coefficient K2 and maximum value i1ₘₐₓ of the index. The second local charge/discharge gain line will be described later.

(3-9) Each apparatus control device 8 uses the second local charge/discharge gain line and the received index to control the charging/discharging operation of storage batteries 9.

Details of the operation of executing DR application 2 (second LFC adjustment operation) are next described.

The operation in which power control device 7 derives total adjustable capacity P_{ES} on the basis of the SOC of storage batteries 9 that execute DR application 2 is first described.

This explanation of the P_{ES} derivation operation is realized by altering the explanation of the P_{ES} derivation operation in DR application 1 described hereinabove as shown below:

Alter “period T1_{FirstLFC}” to “period T1_{SecondLFC}”.

Alter “DR application 1” to “DR application 2”.

The operation in which power control device 7 communicates with load-dispatching unit 2 to comprehend the DR2 charge/discharge gain line (hereinbelow referred to as the “DR2 comprehension operation”) is next described.

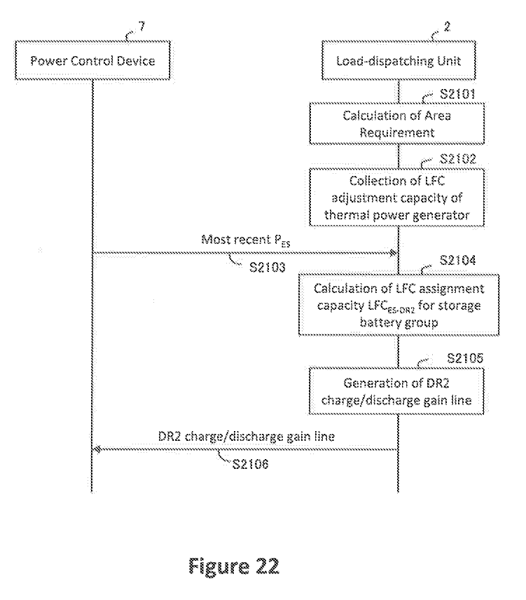

FIG. 22 is a sequence diagram for describing the DR2 comprehension operation.

Control unit 204 of load-dispatching unit 2 uses the system frequency that was detected by frequency meter 201 and the power flow on linking line 4 that was detected by flow detection unit 202 to calculate the Area Requirement AR-1 (Step S2101).

Control unit 205 next collects the LFC adjustment capacity of thermal power generator 1 from the thermal power generator control unit (not shown) (Step S2102).

On the other band, communication unit 701 of power control device 7 transmits the most recent total adjustable capacity P_{ES} to load-dispatching unit 2 (Step S2103).

Communication unit 203 of load-dispatching unit 2 receives the most recent total adjustable capacity P_{ES} from communication unit 701 of power control device 7. Communication unit 203 supplies this most recent total adjustable capacity P_{ES} to control unit 204.

Control unit 204, upon receiving the most recent total adjustable capacity P_{ES}, uses Area Requirement AR-1, the LFC adjustment capacity of thermal power generator 1, and the most recent total adjustable capacity P_{ES} to derive the LFC capacity. Control unit 204 next assigns to thermal power generator 1, of the LFC capacity, the capacity from which the rapid fluctuation component has been removed. Control unit 204 next assigns the remaining LFC capacity LFC_{ES-DR}2 (where LFC_{ES-DR}2≦P_{ES}) to the storage battery group that is to execute DR application 2 as the LFC assignment capacity LFC_{ES-DR}2 (Step S2104).

In determining the ratio of the assignment of the LFC capacity to thermal power generator 1 and LFC assignment capacity LFC_{ES-DR}2, control unit 204 considers economy while also taking account the acceptance of the EDC component.

Control unit 204 next generates DR2 charge/discharge gain line (see FIG. 15B) that shows the LFC assignment capacity LFC_{ES-DR}2 and the maximum value i1fₘₐₓ of the index that was set in advance (Step S2105).

The DR2 charge/discharge gain line shown in FIG. 15B shows the charging/discharging amount of the storage battery group (storage batteries 9 that are to execute DR application 2) with respect to the index. The DR2 charge/discharge gain line changes, becoming line 400C and then line 400D according to the size of the LFC assignment capacity LFC_{ES-DR}2 (LFC_{ES-DR}2 and LFC_{ES-DR}2′) in the range of “LFC assignment capacity LFC_{ES-DR}2≦total adjustable capacity P_{ES}”.

Control unit 204 next transmits the DR2 charge/discharge gain line to power control device 7 by way of communication unit 203 (Step S2106).

Power control device 7 and load-dispatching unit 2 repeat the operations of Steps S2101-S2106 (the DR2 comprehension operation) at period Tₘ.

Comprehension unit 703 of power control device 7 receives the DR2 charge/discharge gain line by way of communication unit 701 and holds, of the DR2 charge/discharge gain lines, the most recent DR2 charge/discharge gain line.

The operations of generating the DR2 allotment information, transmitting the DR2 allotment information to each apparatus control device 8, and the derivation of a second local charge/discharge gain line by which each apparatus control device 8 controls the operation of storage batteries 9 on the basis of the DR2 allotment information (hereinbelow referred to as the “DR2 allotment operation”) are next described.

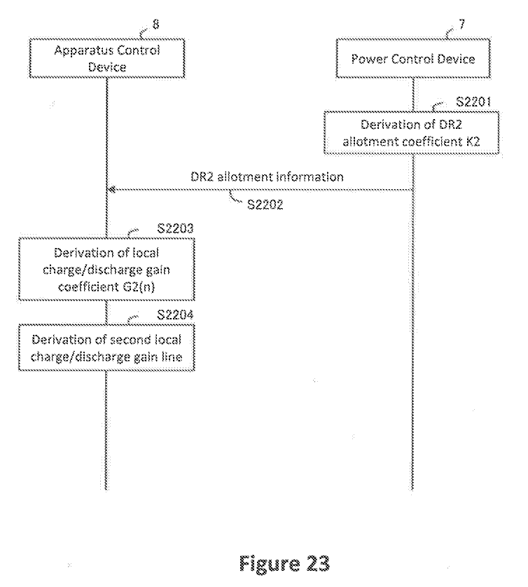

FIG. 23 is a sequence diagram for describing the DR2 allotment operation. In FIG. 23, the number of apparatus control devices 8 that execute DR application 2 has been made “1” in the interest of simplifying the explanation.

Control unit 704 of power control device 7 uses LFC assignment capacity LFC_{ES-DR}2 that is indicated in the most recent DR2 charge/discharge gain line, the most recent total adjustable capacity P_{ES}, and the formula shown in Numerical Expression 5 to derive DR2 allotment coefficient K2 (Step S2201).

$$K 2 = \frac{{LFC}_{ES \cdot DR 2}}{{P}_{ES}} \qquad Numerical Expression 5$$

Control unit 704 next transmits the DR2 allotment information that indicates DR2 allotment coefficient K2 and the maximum value i1ₘₐₓ of the index indicated in the most recent DR2 charge/discharge gain line to each apparatus control device 8 that is to execute DR application 2 by way of communication unit 701 (Step S2202). DR2 allotment coefficient K2 is not limited to the value specified in Numerical Expression 5. For example, a value (such as 0.97) that indicates forcibly making the output close to the limit during times of stringency of power supply and demand. The value indicating output close to the limit is not limited to 0.97 and can be altered as appropriate.

Control unit 704 does not execute Step S2202 for apparatus control devices 8 corresponding to storage batteries 9 for which SOC was not received.

In the present exemplary embodiment, the following process is executed in Step S2202.

Control unit 704 specifies the smaller value of the most recent storage battery distribution ratio α_{discharge}(n) during discharge and storage battery distribution ratio α_{charge}(n) during charge that were derived by comprehension unit 703 as storage battery distribution ratio α_{discharging}(n) for each storage battery 9 that is to execute DR application 2.

Control unit 704 next generates, for each storage battery 9 that is to execute DR application 2, operation-relevant information that shows the storage battery distribution ratio α(n) and rated output P(n) that is being held in database 702.

Control unit 704 then appends DR2 allotment information to each item of operation-relevant information.

Control unit 704 then transmits the DR2 allotment information to which the operation-relevant information has been appended from communication unit 701 to apparatus control devices 8 that accord with the operation-relevant information. The DR2 allotment information to which operation-relevant information has been appended is also one example of the second LFC operation control information.

In apparatus control devices 8 that are to execute DR application 2, control unit 805 receives the DR2 allotment information with appended operation-relevant information by way of communication unit 803.

Control unit 805 uses the DR2 allotment information with appended operation-relevant information and the formula shown in Numerical Expression 6 to derive local charge/discharge gain line G2(n) (Step S2203).

$$G 2 ( n ) = \frac{K 2 \cdot α ( n ) \cdot P ( n )}{i 1 max} \qquad Numerical Expression 6$$

The values in the formula of Numerical Expression 6 are indicated in the DR2 allotment information with appended operation-relevant information.

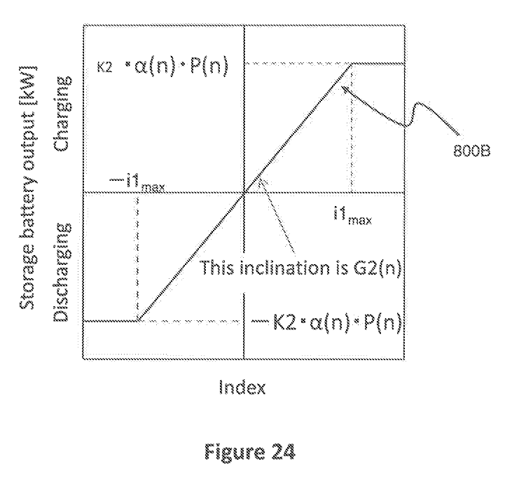

Control unit 805 next uses local charge/discharge gain line G2(n) and the maximum value i1ₘₐₓ of the index shown in DR2 allotment information with appended operation-relevant information to derive second local charge/discharge gain line 800B shown in FIG. 24 (Step S2204).

Second charge/discharge gain line 800B shown in FIG. 24 is a straight line that, in the range in which the index is −i1ₘₐₓ≦index≦i1ₘₐₓ, passes through the origin 0 with an inclination that is local charge/discharge gain line G2(n). In addition, second local charge/discharge gain line 800B is a fixed value of “−K2·α(n)·P(n)” (where the minus sign indicates discharging) in the range in which the index is less than −i1ₘₐₓ. Further, second local charge/discharge gain line 800B is a fixed value of “K2·α(n)·P(n)” in the range in which the index is greater than i1ₘₐₓ.

Power control device 7 and each apparatus control device 8 that is to execute DR application 2 repeat the processes of Steps S2201-S2204 at period T1_{SecondLFC}.

In each apparatus control device 8 that executes DR application 2, control unit 805 receives the DR2 allotment information with appended operation-relevant information by way of communication unit 803 and, of the DR2 allotment information with appended operation-relevant information, holds the most recent DR2 allotment information with appended operation-relevant information.

The operation in which apparatus control devices 8 that execute DR application 2 control charging/discharging of storage batteries 9 on the basis of the DR2 allotment information with appended operation-relevant information and an index (hereinbelow referred to as the “DR2 charging/discharging control operation”) is next described.

At the start time of DR application 2 that is indicated in the time slot information, control unit 704 of power control device 7 transmits DR2 execution interval information that indicates the operation period T3_{SecondLFC} to apparatus control devices 8 that are to execute DR application 2 by way of communication unit 701. Operation period T3_{SecondLFC} is, for example, 1 second. Control unit 805 of apparatus control device 8 that is to execute DR application 2, having received the DR2 execution interval information by way of communication unit 803, holds the DR2 execution interval information.

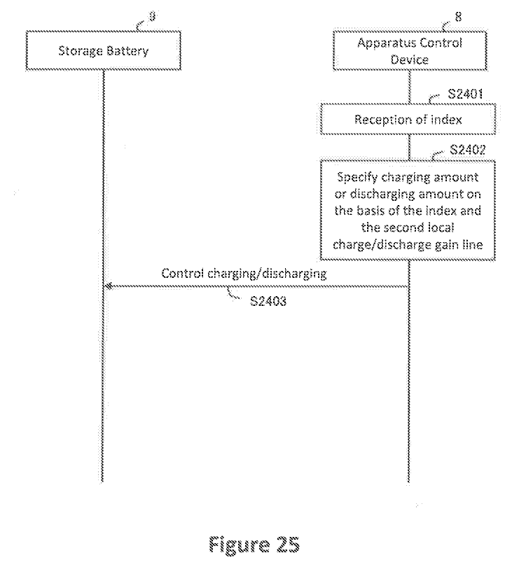

FIG. 25 is a sequence diagram for describing the charging/discharging control operation.

In apparatus control device 8 that is to execute DR application 2, communication unit 803 receives the index that is transmitted by power control device 7 (Step S2401).

Control unit 805 next calculates the charging amount or discharging amount of storage battery 9 that is to execute DR application 2 in accordance with the index received by communication unit 803 and second local charge/discharge gain line (Step S2402).

If the absolute value of the index is no greater than the maximum value (threshold value) i1ₘₐₓ of the index in Step S2402, control unit 805 calculates the absolute value of a value (G2(n)·index) obtained by multiplying the index by the local charge/discharge gain coefficient G2(n) as the adjustment power amount.

On the other hand, if the absolute value of the index is greater than the maximum value i1ₘₐₓ of the index, control unit 805 calculates a value (K2·α(n)·P(n)) that results from multiplying together allotment coefficient K2, storage battery distribution ratio α(n), and rated output P(n) as the adjustment power amount.

Although an example of point symmetry in which the inclination of G2(n) is the same on the charging side and discharging side is shown in FIG. 24, in actuality, a case that lacks point symmetry is also conceivable. In such cases, G2(n) is determined by the same approach as described above.

If the index is a positive value, control unit 805 next causes storage batteries 9 that are to execute DR application 2 to execute a charging operation of the adjustment power amount. Alternatively, if the index is a negative value, control unit 805 causes storage batteries 9 that are to execute DR application 2 to execute a discharging operation of the adjustment power amount (Step S2403).

Each apparatus control device 8 repeats Steps S2401-S2403 at the period T3_{SecondLFC} that was indicated in the DR2 execution interval information. As a result, the value of the index changes each time, charging/discharging being executed each time according to G2(n)·index.

In the present exemplary embodiment, an example was shown of deriving the index, but the index is not limited to an index derived by the method shown in the present exemplary embodiment, and an index that is derived by another method by the load-dispatching unit can also be used. For example, an index can also be considered that is similar to an LFC signal that is distributed by PJM, which is a U.S. ISO (Independent System Operator).

Essentially, although the index changes at each period T3_{SecondLFC} that is shorter than period T1_{SecondLFC}, the charging/discharging operation of storage batteries 9 is carried out using the same DR2 allotment information until period T1_{SecondLFC} (=15 minutes) has elapsed.

As a result, in DR application 2 (second LFC adjustment process), apparatus control device 8 receives the DR2 allotment information at period T1_{SecondLFC} (=15 minutes), receives the index at period T3_{SecondLFC} that is shorter than period T1_{SecondLFC}, and carries out the charging/discharging operation of storage batteries 9 on the basis of the DR2 allotment information and the index at period T3_{SecondLFC}. As described above, the second LFC adjustment process can be accommodated because, while receiving at period T3_{SecondLFC} an index that varies according to the balance between electric power supply and demand, DR2 allotment information that requires bidirectional communication processing and time for acquisition is acquired at a period that is longer than the period of receiving the index.

The effect of the present exemplary embodiment is next described.

According to the present exemplary embodiment, when any of the SOC of storage batteries 9 could not be received within the interval of period T1_{SecondLFC}, generation unit 705 generates DR1 allotment information with appended operation-relevant information for apparatus control devices 8 that correspond to storage batteries 9 for which the SOC could be received during the interval of period T1_{FirstLFC}. Communication unit 701 then transmits the DR1 allotment information with corresponding appended operation-relevant information to apparatus control devices 8 that correspond to storage batteries 9 for which the SOC could be received during the interval of period T1_{FirstLFC}.

As a result, the frequency of generating DR1 allotment information with appended operation-relevant information can be increased compared to a case of generating DR1 allotment information with appended operation-relevant information only when the SOC of all storage batteries 9 could be received in the interval of period T1_{FirstLFC}. Because the SOC that could be received in the interval of period T1_{FirstLFC} is reflected in the DR1 allotment information with appended operation-relevant information, the SOC that could be received can be used effectively without being wasted.

In addition, the amount of communication processing executed by communication unit 701 can be reduced compared to a case of transmitting DR1 allotment information with appended operation-relevant information to all apparatus control devices 8 with each interval of period T1_{FirstLFC}.

In addition, when the SOC of any of storage batteries 9 could not be received in the interval of period T1_{SecondLFC}, generation unit 705 generates DR2 allotment information with appended operation-relevant information for apparatus control devices 8 that correspond to storage batteries 9 for which the SOC could be received in the interval of period T1_{SecondLFC}. Communication unit 701 then transmits the corresponding DR2 allotment information with appended operation-relevant information to apparatus control devices 8 that correspond to storage batteries 9 for which the SOC could be received in the interval of period T1_{SecondLFC}.

As a result, the frequency of generating DR2 allotment information with appended operation-relevant information can be increased compared to a case of generating DR2 allotment information with appended operation-relevant information only when the SOC of all storage batteries 9 could be received in the interval of period T1_{SecondLFC}. Because the SOC that could be received in the interval of period T1_{SecondLFC} is reflected in the DR2 allotment information with appended operation-relevant information, the SOC that could be received can be used effectively without being wasted.

In addition, the amount of communication processing executed by communication unit 701 can be reduced compared to a case of transmitting DR2 allotment information with appended operation-relevant information to all apparatus control devices 8 for each interval of period T1_{SecondLFC}.

A modification of the present exemplary embodiment is next described.

In addition, when the SOC of all storage batteries 9 that are to execute DR application 1 could be received in the interval of period T1_{FirstLFC}, generation unit 705 may also generate DR1 allotment information with appended operation-relevant information of a portion of these storage batteries 9 on the basis of the SOC of that portion of storage batteries 9. In this case, communication unit 701 transmits DR1 allotment information with appended operation-relevant information of the portion of storage batteries 9 to apparatus control devices 8 that correspond to that portion of storage batteries 9.

In this case, the amount of communication processing that is executed by communication unit 701 can be reduced compared to a case in which communication unit 701 transmits DR1 allotment information with appended operation-relevant information to each corresponding apparatus control device 8 of all storage batteries 9 that are to execute DR application 1.

In addition, when the SOC of all storage batteries 9 that execute DR application 2 could be received in the interval of period T1_{SecondLFC}, generation unit 705 may also generate DR2 allotment information with appended operation-relevant information of a portion of these storage batteries 9 on the basis of the SOC of this portion of storage batteries 9. In this case, communication unit 701 transmits DR2 allotment information with appended operation-relevant information of the portion of storage batteries 9 to apparatus control devices 8 that correspond to this portion of storage batteries 9.

In this case, the amount of communication processing executed by communication unit 701 can be reduced compared to a case in which communication unit 701 transmits DR2 allotment information with appended operation-relevant information to each corresponding apparatus control device 8 of all storage batteries 9 that are to execute DR application 2.

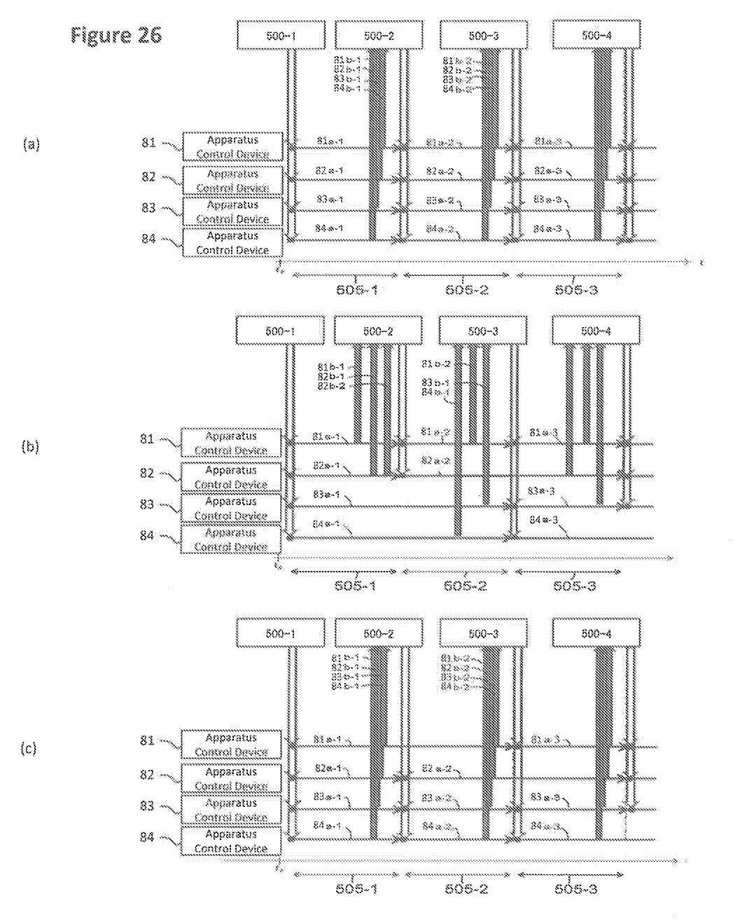

FIG. 26 shows the fourth exemplary embodiment, the above-described modification of the fourth exemplary embodiment, and a comparative example. FIG. 26(a), FIG. 26(b), and FIG 26(c) correspond to the comparative example, the fourth exemplary embodiment, and the above-described modification of the fourth exemplary embodiment, respectively.

FIG. 26 shows parts that relate to the transmission of the SOC of storage batteries 9 and the transmission of DR1 allotment information with appended operation-relevant information. “DR1 allotment information with appended operation-relevant information” is hereinbelow referred to as “operation control information”.

In FIG. 26, the number of apparatus control devices 8 is “4,” the four apparatus control devices 8 are shown as apparatus control devices 81-84, and the operation of power control device 7 is shown at timings 500-1-500-4 of period T1_{FirstLFC} intervals. In the interest of simplifying the explanation, the same reference numbers are applied in the configuration of the comparative example as in the fourth exemplary embodiment and the above-described modification of the fourth exemplary embodiment.

The comparative example shown in FIG. 26(a) is first described.

Apparatus control devices 81-84 each transmit SOC 81b-84b of corresponding storage batteries 9 to power control device 7 at period T1_{FirstLFC} (for example, 15 minutes).

Power control device 7, when having received the SOC of storage batteries 9 from all apparatus control devices 81-84, transmits operation control information 81a-84a that accords with the SOC of storage batteries 9 to apparatus control devices 81-84, respectively. Power control device 7 executes the process of transmitting the operation control information at period T1_{FirstLFC}.

Apparatus control devices 81-84 each control charging/discharging of corresponding storage batteries 9 at period T2-A (for example, 1 second) on the basis of operation control information 81a-84a that was received from power control device 7 at period T1_{FirstLFC} and the system frequency (integrated value of frequency deviation) that was acquired at period T2-A.

For example, an operation such as shown below is executed in interval 505-1.

Apparatus control devices 81-84 each transmit SOC 81b-1-84b-1 of corresponding storage batteries 9 to power control device 7.

Power control device 7 receives SOC 81b-1-84b-1 of storage batteries 9 from apparatus control device 81-84 and transmits operation control information 81a-2-84a-2 that accord with the SOC of storage batteries 9 to apparatus control devices 81-84.

In interval 505-2 that follows interval 505-1, apparatus control devices 81-84 control the charging/discharging of corresponding storage batteries 9 at period T2-A on the basis of operation control information 81a-2-84a-2 and system frequency (the integrated value of frequency deviation) that was acquired at period T2-A.

In this comparative example, however, when the SOC could not be received from at least any one of apparatus control devices 81-84 during period T1_{FirstLFC}, power control device 7 does not execute the process of generating or distributing operation control information.

As a result, if failure to receive the SOC of storage battery 9 in at least any one of apparatus control devices 81-84 continues to occur, any item of operation control information will not be updated. The problem consequently arises that accurate power supply/demand adjustment cannot be achieved.

On the other hand, in the fourth exemplary embodiment (see FIG. 26(b)), when any SOC of storage batteries 9 cannot be received during period T1_{FirstLFC}, power control device 7 generates and transmits operation control information for apparatus control devices 8 that corresponds to storage batteries 9 for which SOC could be received during that period T1_{FirstLFC}.

For example, in interval 505-1, the following operation is executed.

Apparatus control device 81 transmits SOC 81b-1 of corresponding storage battery 9 to power control device 7. In addition, apparatus control device 82 transmits SOC 82b-1 and SOC 82b-2 of corresponding storage batteries 9 to power control device 7.

Power control device 7 receives SOC 81b-1 of storage battery 9 from apparatus control device 81 and receives SOC 82b-1 and SOC 82b-2 of storage batteries 9 from apparatus control device 82. Power control device 7 then transmits operation control information 81a-2-82a-2 that accords with the SOC (most recent SOC) of each of storage batteries 9 to apparatus control devices 81-82. At this time, power control device 7 does not transmit operation control information to apparatus control devices 83 and 84 for which the SOC of storage batteries was not received.

In interval 505-2 that follows interval 505-1, apparatus control devices 81-82 control the charging/discharging of corresponding storage batteries 9 at period T2-A on the basis of operation control information 81a-2 and 82a-2 and the system frequency (integrated value of frequency deviation) that was acquired at period T2-A. On the other hand, in interval 505-2, apparatus control devices 83-84 control the charging/discharging of corresponding storage batteries 9 at period T2-A on the basis of the most recent operation control information among the operation control information that was received before interval 505-1 (in the example shown in FIG. 26(b), operation control information 83a-1 and 84a-1) and the system frequency (integrated value of frequency deviation) that was acquired at period T2-A.

As a result, according to the fourth exemplary embodiment, of apparatus control devices 81-84, in the event of continued circumstances in which the SOC of at least any one storage battery 9 cannot be received, at least some operation control information is updated. As a result, power supply/demand adjustment can be executed with greater precision than in the comparative example.

In addition, the amount of processing required for transmitting operation control information can be reduced compared to a case in which operation control information must be transmitted to each and every apparatus control device 81-84 that are under control.

In addition, in the comparative example shown in FIG. 26(a), when the number of apparatus control devices 8 becomes large, the problem arises in which the amount of communication processing between power control device 7 and apparatus control devices 8 becomes great.

On the other hand, in the modification of the fourth exemplary embodiment (FIG. 26(c), when the SOC of all storage batteries 9 could be received in the interval of period T1_{FirstLFC}, power control device 7 generates and transmits operation control information for apparatus control devices 8 that correspond to a portion of storage batteries 9 on the basis of the SOC of this portion of storage batteries 9.

For example, the following operations are executed in interval 505-1.

Apparatus control devices 81-84 transmit SOC 81b-1-84b-1 of respectively corresponding storage batteries 9 to power control device 7.

Power control device 7 transmits to apparatus control devices 82-84 operation control information 82a-2-84a-2 that accord with SOC 82b-1-84b-1 of storage batteries 9. At this time, power control device 7 does not transmit operation control information to apparatus control device 81.

In interval 505-2 that follows interval 505-1, apparatus control devices 82-84 control the charging/discharging of corresponding storage batteries 9 at period T2-A on the basis of operation control information 82a-2-84a-2 and the system frequency (integrated value of frequency deviation) that was acquired at period T2-A. On the other hand, in interval 505-2, apparatus control device 81 controls the charging/discharging of corresponding storage battery 9 at period T2-A on the basis of the most recent operation control information among the operation control information that was received before interval 505-1 (operation control information 83a-1 in FIG. 26(c)) and the system frequency (integrated value of frequency deviation) that was acquired at period T2-A.

As a result, according to the modification of the fourth exemplary embodiment, the amount of communication processing between power control device 7 and apparatus control devices 8 can be reduced compared to the comparative example even when the number of apparatus control devices 8 becomes large.

In the modification of the fourth exemplary embodiment, power control device 7 switches apparatus control devices 8 for which operation control information is not transmitted for each period T1_{FirstLFC} as shown in, for example, FIG. 26(c). As a result, the updating interval of each item of operation control information can be averaged.

In addition, as another modification, a configuration may be used that only executes either of DR application 1 or DR application 2. When DR application 2 is executed but DR application 1 is not executed, detection unit 801 may be omitted.

The power supply/demand adjustment process is not limited to LFC and can be altered as appropriate. For example, a peak-cutting process that executes electric power peak-cutting or a GF (Governor Free) adjustment process may be used as the power supply/demand adjustment process. When, for example, a GF adjustment process is adopted, “frequency deviation” may be used instead of the above-described “index” or “integrated value of frequency deviation”.

When discharging (reverse power flow) from storage battery 9 (consumer side) to power system 3 is prohibited, control unit 805 causes the discharge power of storage battery 9 to be discharged within the range of the power consumption amount of load 10 of the consumer. Load 10, by consuming the discharged power of storage battery 9, reduces the power demand upon power system 3.

When discharging (reverse power flow) from storage battery 9 (consumer side) to power system 3 is not prohibited, control unit 805 may supply the discharged power of storage battery 9 to power system 3.

In the above-described exemplary embodiments, each of control devices A, B, C, apparatus control devices D1, and 8, and power control device 7 may be realized by a computer. In such cases, the computer reads and executes a program that is recorded on a recording medium that can be read by a computer to execute the functions of any of control devices A, B and C, apparatus control devices D1 and 8, and power control device 7. The recording medium is, for example, a CD-ROM (Compact Disk-Read Only Memory). The recording medium is not limited to a CD-ROM and may be altered as appropriate.

In each of the above-described exemplary embodiments, the configurations shown in the figures are merely examples, and the present invention is not limited to these configurations.

In addition, although the invention of the present application has been described with reference to exemplary embodiments, the invention of the present application is not limited to the above-described exemplary embodiments. The configuration and details of the invention of the present application are open to various modifications within the scope of the invention of the present application that will be clear to one of ordinary skill in the art.

This application claims the benefits of priority based on Japanese Patent Application No. 2015-068856 for which application was submitted on Mar. 30, 2015 and incorporates by citation all of the disclosures of that application.

### EXPLANATION OF THE REFERENCE NUMBERS

A, B, C control device
A1, B1, C1 generation unit
A2 transmission unit
C2 communication unit
D power supply/demand adjustment device
D1 apparatus control device
D1a communication unit
D1b detection unit
D1c control unit
R1 power system
R2 storage battery
R3 linking line
R4 another power system
1000 Power control system
1 thermal power plant
2 load-dispatching unit
201 frequency meter
202 flow detection unit
203 communication unit
204 control unit
3 power system
4 linking line
5 distribution transformer
6 power line
7 power control device
701 communication unit
702 database
703 comprehension unit
704 control unit
705 generation unit
8 apparatus control device
801, 802 detection unit
803 communication unit
804 determination unit
805 control unit
9 storage battery
10 load
111 renewable power source (photovoltaic power generator)
112 renewable power source (wind power generator)

1. A control device that controls a plurality of power supply/demand adjustment devices comprises:
a generation unit that, on the basis of status information of a portion of said plurality of power supply/demand adjustment devices that is received from said portion of power supply/demand adjustment devices, generates operation control information of said portion of power supply/demand adjustment devices; and
a transmission unit that transmits said operation control information to said portion of power supply/demand adjustment devices.

2. The control device according to claim 1, wherein said generation unit generates operation control information of the portion of power supply/demand adjustment devices on the basis of status information of said portion of said power supply/demand adjustment devices that is received within a predetermined interval.

3. The control device according to claim 2, wherein, when status information of said plurality of power supply/demand adjustment devices is not received within said predetermined interval, said generation unit generates operation control information of said portion of power supply/demand adjustment devices on the basis of status information of a portion of said power supply/demand adjustment devices that was received within said predetermined interval.

4. The control device according to claim 1, wherein said generation unit repeatedly executes the operation of generating said operation control information at an interval of said predetermined interval.

5. The control device according to claim 1, wherein said generation unit generates said operation control information on the basis of status information of said portion of power supply/demand adjustment devices in status information of said plurality of power supply/demand adjustment devices that was received.

6. The control device according to claim 5, wherein, when executing said operation a predetermined number of times, said generation unit generates, in place of operation control information of said portion of power supply/demand adjustment devices, operation control information of power supply/demand adjustment devices that are different from said portion of power supply/demand adjustment devices on the basis of status information of the different power supply/demand adjustment devices.

7. The control device according to claim 5, wherein said generation unit, when executing said operation a predetermined number of times, selects, as said portion of power supply/demand adjustment devices, power supply/demand adjustment devices that have not been selected as said portion of power supply/demand adjustment devices.

8. The control device according to claim 5, wherein said generation unit selects said portion of power supply/demand adjustment devices on the basis of characteristic identification numbers that relate to said power supply/demand adjustment devices.

9. The control device according to claim 1, wherein said generation unit generates said operation control information of said portion of power supply/demand adjustment devices on the basis of said status information that was received before said predetermined interval from power supply/demand adjustment devices that differ from, of said plurality of power supply/demand adjustment devices, said portion of power supply/demand adjustment devices and said status information that was received within said predetermined interval.

10. The control device according to claim 1, wherein the operation control information of said portion of power supply/demand adjustment devices is information that specifies the relation between the operation of said portion of power supply/demand adjustment devices and adjustment amount information that relates to the power adjustment amount undertaken by said control device.

11. The control device according to claim 10, wherein said generation unit generates said operation control information at a period that is longer than the period of acquiring said adjustment amount information in said portion of power supply/demand adjustment devices.

12. The control device according to claim 1, wherein said transmission unit transmits said operation control information to said portion of power supply/demand adjustment devices for each generation of said operation control information by said generation unit.

13. The control device according to claim 1, wherein said generation unit:
generates operation control information on the basis of status information of said plurality of supply/demand adjustment devices at the operation start time; and
generates operation control information of the portion of power supply/demand adjustment devices on the basis of status information of a portion of said power supply/demand adjustment devices that was received within said predetermined interval after the operation start time.

14. An apparatus control device that controls operation of a supply/demand adjustment devices that is connected to a power system, comprising:
detection means that detects the status of said supply/demand adjustment device;
communication means that transmits the detection result of said detection means to an external device and that receives from the external device operation control information that controls the operation of said supply/demand adjustment device; and
control means that replaces operation control information that is being held with operation control information that is received from said communication means and, on the basis of said operation control information following replacement, controls the operation of said supply/demand adjustment device.

15. The apparatus control device according to claim 14, further comprising reception means that receives an index that relates to an adjustment power amount that is transmitted by bidirectional communication or one-way communication;
wherein said control means controls the operation of said supply/demand adjustment device on the basis of said operation control information that follows replacement and on the basis of said index.

16. The apparatus control device according to claim 14, further comprising a detection unit that detects the state of a power system;
wherein said control means controls the operation of said supply/demand adjustment device on the basis of said operation control information that follows replacement and on the basis of the state of said power system.

17. The apparatus control device according to claim 15, wherein, when said operation control information was not received within a predetermined interval, said control means controls the operation of said supply/demand adjustment device on the basis of said operation control information that is being held and on the basis of said index.

18. The apparatus control device according to claim 15, wherein said communication means receives said index at a shorter interval than the interval of receiving said operation control information and receives said index and said operation control information at each predetermined interval.

19. The apparatus control device according to claim 16, wherein, when said operation control information was not received in a predetermined interval, said control means controls the operation of said supply/demand adjustment device on the basis of said operation control information that is being held and on the basis of the state of said power system.

20. A control system that includes a first control device that controls the operation of a power supply/demand adjustment device that is connected to a power system, and a second control device that communicates with said first control device, wherein:
said first control device includes:
a detection unit that detects a status relating to said power supply/demand adjustment device;
a communication unit that transmits to said second control device status information that indicates the status relating to said power supply/demand adjustment device that was detected in said detection unit and that receives from said second control device operation control information that controls the operation of said power supply/demand adjustment device; and
a control unit that replaces operation control information that is being held with operation control information that was received by said communication unit and that controls the operation of said power supply/demand adjustment device on the basis of said operation control information; and
said second control device includes:
a generation unit that, on the basis of status information of a portion of a plurality of power supply/demand adjustment devices that was received from said portion of power supply/demand adjustment devices, generates operation control information of said portion of power supply/demand adjustment devices; and
a transmission unit that transmits said operation control information to said portion of power supply/demand adjustment devices.

21.-24. (canceled)
